(19) United States
(12) Patent Application Publication
(10) Pub. No.: US 2024/0144506 A1
(43) Pub. Date: May 2, 2024

(54) INFORMATION PROCESSING DEVICE

(71) Applicant: Sony Semiconductor Solutions Corporation, Kanagawa (JP)

(72) Inventor: Yuji Hanada, Tokyo (JP)

(21) Appl. No.: 18/279,151

(22) PCT Filed: Mar. 8, 2022
(86) PCT No.: PCT/JP2022/010089

§ 371 Date: Aug. 28, 2023

(30) Foreign Application Priority Data
Mar. 22, 2021 (JP) 2021-047687

(51) Int. Cl. G06T 7/55; G01S 17/894

(52) U.S. Cl. CPC G06T 7/55; G01S 17/894; G01S 7/4808; G06T 2207/20084

(57) ABSTRACT

An object is to enable accurate detection of an erroneous distance measurement result. An information processing device according to the present technology includes a processing unit that performs processing using a machine-learned learning model on at least a part of first distance measurement information acquired by a first sensor, and outputs second distance measurement information after being subjected to correction of a correction target pixel included in the first distance measurement information, the processing including: first processing of correcting the correction target pixel using the first distance measurement information including the correction target pixel and image information acquired by a second sensor as inputs; and second processing of outputting the second distance measurement information.

### TECHNICAL FIELD

The present technology relates to an information processing device capable of measuring a distance to a target.

### BACKGROUND ART

In recent years, advances in semiconductor technology have led to miniaturization of distance measuring devices that measure a distance to a target. Therefore, it is possible to install the distance measuring devices in, for example, so-called mobile terminals, such as smartphones, which are small information processing devices having communication functions. Examples of the distance measuring devices (sensors) that measure a distance to a target include a time of flight (TOF) sensor (see, for example, Patent Document 1).

### CITATION LIST

### Patent Document

Patent Document 1: Japanese Translation of PCT Application No. 2014-524016

### SUMMARY OF THE INVENTION

### Problems to be Solved by the Invention

In a case where there is an erroneous distance measurement result, it is desired to improve the accuracy of distance measurement itself by accurately detecting the erroneous distance measurement result.

The present technology has been made in view of such circumstances, and enables accurate detection of an erroneous distance measurement result.

### Solutions to Problems

An information processing device of the present technology includes a processing unit that performs processing using a machine-learned learning model on at least a part of first distance measurement information acquired by a first sensor, and outputs second distance measurement information after being subjected to correction of a correction target pixel included in the first distance measurement information, the processing including: first processing of correcting the correction target pixel using the first distance measurement information including the correction target pixel and image information acquired by a second sensor as inputs; and second processing of outputting the second distance measurement information.

Therefore, the second distance measurement information based on a correlation between the input image information and first distance measurement information is output using the machine-learned learning model.

It is conceivable that the information processing device described above uses the image information based on a signal obtained by photoelectrically converting visible light as the input in the first processing. Therefore, the second distance measurement information based on a correlation (similarity in in-plane tendency) between an object (feature) recognized from luminance and color distribution of the image information and the first distance measurement information is obtained.

It is conceivable that the information processing device described above uses the image information based on a signal obtained by photoelectrically converting light polarized in a predetermined direction as the input in the first processing. Therefore, the second distance measurement information based on a correlation (similarity in in-plane tendency) between the same plane (feature) of an object recognized from deflection angle distribution of the image information and the first distance measurement information is obtained.

In the information processing device described above, it is conceivable that the learning model includes a neural network trained with a data set detecting the correction target pixel. The neural network is a model imitating a human cranial nerve circuit, and includes, for example, three types of layers of an input layer, an intermediate layer (hidden layer), and an output layer.

In the information processing device described above, it is conceivable that the first processing includes a first step of detecting the correction target pixel, and processing using the learning model is performed in the first step. Therefore, detection information of the correction target pixel is obtained by inputting the image information and the first distance measurement information.

In the information processing device described above, it is conceivable that the first processing includes a second step of correcting the detected correction target pixel, and processing using the learning model is performed in the second step. Therefore, the second distance measurement information is obtained by inputting the image information, the first distance measurement information, and the detection information of the correction target pixel.

In the information processing device described above, for example, the first distance measurement information is a pre-correction depth map, and the second distance measurement information is a post-correction depth map. The depth map has, for example, data (distance information) related to distance measurement of each pixel, and a group of pixels can be represented by an XYZ coordinate system (a Cartesian coordinate system or the like) or a polar coordinate system. The depth map sometimes includes data related to correction of each pixel.

In the information processing device described above, for example, the correction target pixel is a flying pixel. The flying pixel means an erroneously detected pixel occurring near an edge of an object.

It is conceivable that the information processing device described above further includes the first sensor, and the first sensor includes the processing unit. Therefore, the first processing and the second processing are performed in the first sensor.

It is conceivable that the information processing device described above is configured as a mobile terminal or a server. Therefore, the first processing and the second processing are performed by devices other than the first sensor.

### BRIEF DESCRIPTION OF DRAWINGS

FIG. 1 is a view illustrating a configuration of an embodiment of a distance measuring system to which the present technology is applied.

FIG. 2 is a diagram illustrating a configuration example of a light receiving unit.

FIG. 3 is a diagram illustrating a configuration example of a pixel.

FIG. 4 is a diagram for describing distribution of charge in the pixel.

FIG. 5 is a view for describing a flying pixel.

FIG. 6 is a view for describing the flying pixel.

FIG. 7 is a view for describing the flying pixel.

FIG. 8 is a view for describing the flying pixel.

FIG. 9 is a diagram illustrating a configuration example of a system including a device that performs AI processing.

FIG. 10 is a block diagram illustrating a configuration example of an electronic device.

FIG. 11 is a block diagram illustrating a configuration example of an edge server or a cloud server.

FIG. 12 is a block diagram illustrating a configuration example of an optical sensor.

FIG. 13 is a block diagram illustrating a configuration example of a processing unit.

FIG. 14 is a flowchart describing a flow of processing using AI.

FIG. 15 is a flowchart describing a flow of correction processing.

FIG. 16 is a flowchart describing a flow of processing using AI.

FIG. 17 is a diagram illustrating an example of a learning model.

FIG. 18 is a flowchart describing a flow of learning processing.

FIG. 19 is a diagram illustrating an example of a learning model.

FIG. 20 is a flowchart describing a flow of learning processing.

FIG. 21 is a diagram illustrating an example of a learning model.

FIG. 22 is a flowchart describing a flow of learning processing.

FIG. 23 is a diagram illustrating an example of a learning model.

FIG. 24 is a flowchart describing a flow of learning processing.

FIG. 25 is a diagram illustrating a flow of data between a plurality of devices.

### MODE FOR CARRYING OUT THE INVENTION

A mode for carrying out the present technology (hereinafter, referred to as an embodiment) will be described.

The present technology can be applied to, for example, a light receiving element constituting a distance measuring system that measures a distance by an indirect TOF method, an imaging device having such a light receiving element, and the like.

For example, the distance measuring system can be applied to an in-vehicle system that is mounted on a vehicle and measures a distance to a target object outside the vehicle, a system for gesture recognition that measures a distance to a target object such as a hand of a user, and recognizes the gesture of the user on the basis of a result of the measurement, and the like. In this case, a result of the gesture recognition can be used for, for example, an operation of a car navigation system or the like.

Furthermore, the distance measuring system can be applied to a control system that is mounted on a work robot provided in a processed food production line or the like, measures a distance from a robot arm to a gripping target object, and approaches the robot arm to an appropriate gripping point on the basis of a result of the measurement, and the like.

Moreover, when design and construction progress management is performed at a construction site or an interior construction site, the distance measuring system can also be used to acquire modeling information based on color images and distance information of the site to be compared with design information (computer-aided design (CAD)).

<1. Configuration Example of Distance Measuring Device>

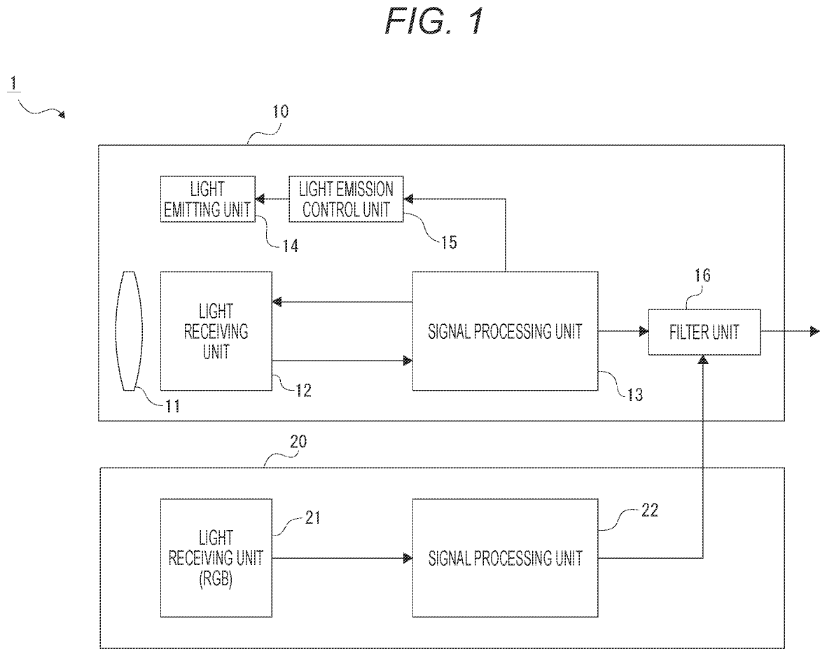

FIG. 1 illustrates a configuration example of an embodiment of a distance measuring system 1 to which the present technology is applied.

The distance measuring system 1 includes a two-dimensional distance measuring sensor 10 and a two-dimensional image sensor 20. The two-dimensional distance measuring sensor 10 measures a distance to an object by irradiating the object with light and receiving light (reflected light) of the light (irradiation light) reflected from the object. The two-dimensional image sensor 20 receives visible light having RGB wavelengths and generates an image (RGB image) of a subject. The two-dimensional distance measuring sensor 10 and the two-dimensional image sensor 20 are arranged in parallel, and the same angle of view is secured.

The two-dimensional distance measuring sensor 10 includes a lens 11, a light receiving unit 12, a signal processing unit 13, a light emitting unit 14, a light emission control unit 15, and a filter unit 16.

A light emitting system of the two-dimensional distance measuring sensor 10 includes the light emitting unit 14 and the light emission control unit 15. In the light emitting system, the light emission control unit 15 causes the light emitting unit 14 to emit infrared light (IR) in accordance with the control from the signal processing unit 13. An IR band filter may be provided between the lens 11 and the light receiving unit 12, and the light emitting unit 14 may emit infrared light corresponding to a transmission wavelength band of the IR bandpass filter.

The light emitting unit 14 may be arranged inside a housing of the two-dimensional distance measuring sensor 10 or may be arranged outside the housing of the two-dimensional distance measuring sensor 10. The light emission control unit 15 causes the light emitting unit 14 to emit light in a predetermined frequency.

The light receiving unit 12 is a light receiving element constituting the distance measuring system 1 that performs distance measurement by the indirect TOF method, and can be, for example, a complementary metal oxide semiconductor (CMOS) sensor.

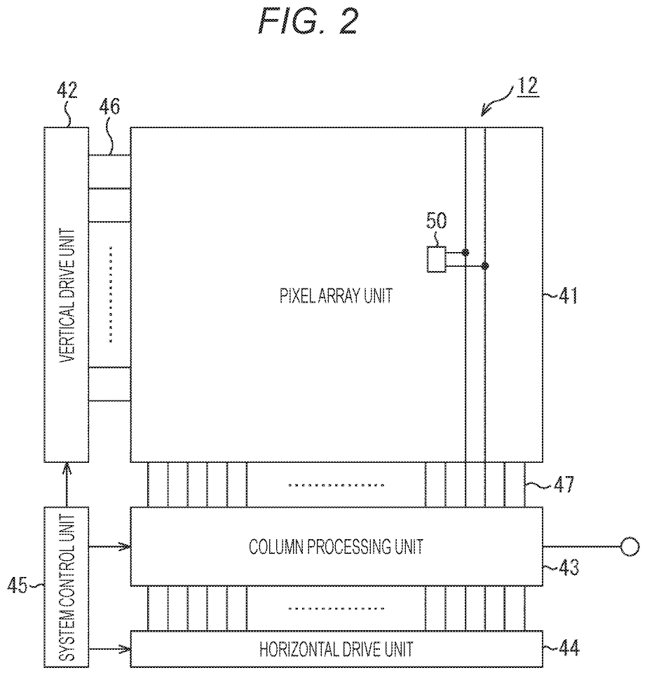

For example, the signal processing unit 13 functions as a calculation unit that calculates a distance (depth value) from the two-dimensional distance measuring sensor 10 to a target on the basis of a detection signal supplied from the light receiving unit 12. The signal processing unit 13 generates distance measurement information from the depth value of each of pixels 50 (FIG. 2) of the light receiving unit 12 and outputs the distance measurement information to the filter unit 16. As the distance measurement information, for example, a depth map having data (distance information) related to the distance measurement of each pixel can be used. In the depth map, a group of pixels can be represented by an XYZ coordinate system (such as a Cartesian coordinate system) or a polar coordinate system. The depth map sometimes includes data related to correction of each pixel. Note that the distance measurement information may include a luminance value or the like in addition to the depth information such as the distance information (depth value).

Meanwhile, the two-dimensional image sensor 20 includes a light receiving unit 21 and a signal processing unit 22. The two-dimensional image sensor 20 is formed with a CMOS sensor, a charge coupled device (CCD) sensor, or the like. The spatial resolving power (the number of pixels) of the two-dimensional image sensor 20 is configured to be higher than that of the two-dimensional distance measuring sensor 10.

The light receiving unit 21 includes a pixel array unit in which pixels are two-dimensionally arranged and red (R), green (G), or blue (B) color filters are arranged in a Bayer array or the like, and supplies a signal obtained by photoelectrically converting visible light having an R, G, or B wavelength received by each pixel to the signal processing unit 22 as an imaging signal.

The signal processing unit 22 performs color information interpolation processing or the like using any pixel signal of an R signal, a G signal, and a B signal supplied from the light receiving unit 21 to generate an image signal including the R signal, the G signal, and the B signal for every pixel, and supplies the image signal to the filter unit 16 of the two-dimensional distance measuring sensor 10.

Furthermore, a polarizing filter that transmits light in a predetermined polarization direction may be provided on a light incident surface of an image sensor of the two-dimensional image sensor 20. A polarization image signal based on the light polarized in the predetermined polarization direction by the polarizing filter is generated. The polarizing filter has, for example, four polarization directions, and in this case, polarization image signals in the four directions are generated. The generated polarization image signal is supplied to the filter unit 16.

<2. Configuration of Imaging Element>

FIG. 2 is a block diagram illustrating a configuration example of the light receiving unit 12 of the two-dimensional distance measuring sensor 10. The light receiving unit 12 includes a pixel array unit 41, a vertical drive unit 42, a column processing unit 43, a horizontal drive unit 44, and a system control unit 45. The pixel array unit 41, the vertical drive unit 42, the column processing unit 43, the horizontal drive unit 44, and the system control unit 45 are formed on a semiconductor substrate (chip) (not illustrated).

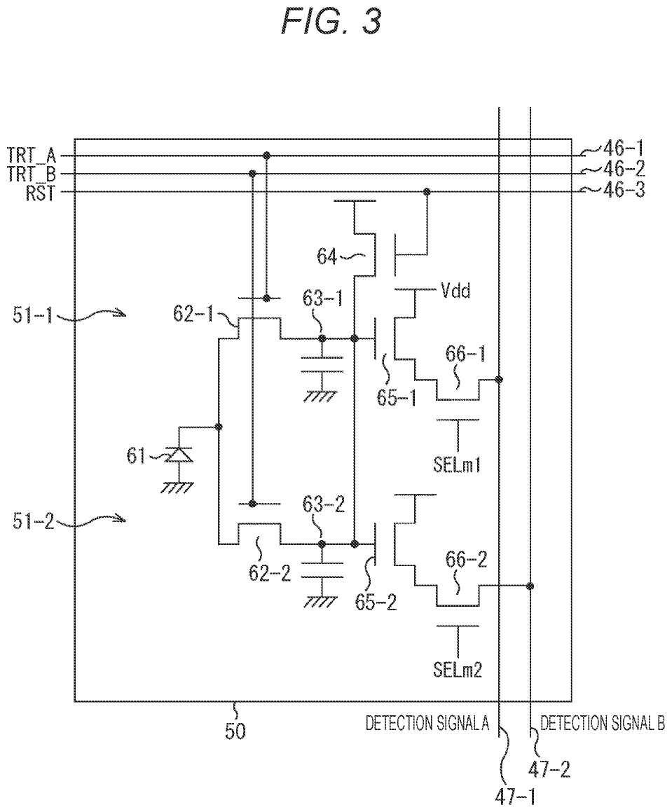

In the pixel array unit 41, unit pixels (for example, the pixels 50 in FIG. 3) are two-dimensionally arrayed in a matrix, each unit pixel having a photoelectric conversion element that generates photocharge in a charge amount corresponding to an amount of incident light and accumulates the generated photocharge therein. Note that there is a case where the photocharge in the charge amount corresponding to the amount of incident light is simply referred to as “charge” hereinafter, and the unit pixel is simply referred to as “pixel”.

The pixel array unit 41 is also provided with pixel drive lines 46, formed for each row along the horizontal direction (arraying direction of pixels in each pixel row) in the drawings, and vertical signal lines 47, formed for each column along the vertical direction (arraying direction of pixels in each column) in the drawings, with respect to the pixels arrayed in a matrix. One end of the pixel drive line 46 is connected to an output terminal corresponding to each row of the vertical drive unit 42.

The vertical drive unit 42 includes a shift register and an address decoder, and is a pixel drive unit that drives pixels of the pixel array unit 41 at the same time for all pixels or in units of rows. Pixel signals output from the unit pixels in the pixel row selectively scanned by the vertical drive unit 42 are supplied to the column processing unit 43 through the corresponding vertical signal lines 47. The column processing unit 43 performs, for each pixel column of the pixel array unit 41, predetermined signal processing on pixel signals output from the unit pixels in the selected row through the vertical signal lines 47, and temporarily stores the pixel signals which have been subjected to the predetermined signal processing.

Specifically, as the signal processing, the column processing unit 43 performs at least noise removal processing, for example, correlated double sampling (CDS). By the correlated double sampling by the column processing unit 43, fixed pattern noise unique to the pixel such as reset noise and threshold variation of an amplification transistor is removed. Note that the column processing unit 43 can have, for example, an analog-digital (AD) conversion function in addition to the noise removal processing, and can output a signal level as a digital signal.

The horizontal drive unit 44 includes a shift register and an address decoder, and sequentially selects unit circuits corresponding to pixel columns of the column processing unit 43. Through the selective scanning by the horizontal drive unit 44, the pixel signals that have been subjected to the signal processing by the column processing unit 43 are sequentially output to the signal processing unit 13 in FIG. 1.

The system control unit 45 includes a timing generator that generates various timing signals, and performs drive control for the vertical drive unit 42, the column processing unit 43, the horizontal drive unit 44, and the like on the basis of the various timing signals generated by the timing generator.

In the pixel array unit 41, with respect to the pixel array matrix, the pixel drive line 46 extends along the row direction for each pixel row, and two vertical signal lines 47 extend along the column direction for each pixel column. For example, the pixel drive line 46 transmits a drive signal for performing driving when a signal is read from a pixel. Note that the pixel drive line 46 is illustrated as one wiring in FIG. 2, but is not limited to one. One end of the pixel drive line 46 is connected to an output terminal corresponding to each row of the vertical drive unit 42.

<3. Structure of Unit Pixel>

Next, a specific structure of each of the unit pixels 50 arrayed in a matrix in the pixel array unit 41 will be described with reference to FIG. 3.

The pixel 50 includes a photodiode 61 (hereinafter, referred to as PD 61) which is the photoelectric conversion element, and is configured such that charge generated by the PD 61 is distributed to a tap 51-1 and a tap 51-2. Then, charge distributed to the tap 51-1 out of the charge generated by the PD 61 is read out from a vertical signal line 47-1 and output as a detection signal SIG1. Furthermore, charge distributed to the tap 51-2 is read out from a vertical signal line 47-2 and output as a detection signal SIG2.

The tap 51-1 includes a transfer transistor 62-1, floating diffusion (FD) 63-1, a reset transistor 64, an amplification transistor 65-1, and a selection transistor 66-1. Similarly, the tap 51-2 includes a transfer transistor 62-2, FD 63-2, the reset transistor 64, an amplification transistor 65-2, and a selection transistor 66-2.

Note that the reset transistor 64 may be shared by the FD 63-1 and the FD 63-2, or may be provided in each of the FD 63-1 and the FD 63-2.

In a case where the reset transistor 64 is provided in each of the FD 63-1 and the FD 63-2, a reset timing can be controlled for each of the FD 63-1 and the FD 63-2, and thus, fine control can be performed. In a case where the reset transistor 64 common to the FD 63-1 and the FD 63-2 is provided, the same reset timing can be set for the FD 63-1 and the FD 63-2, control is simplified, and a circuit configuration can also be simplified.

In the following description, the description will be continued by exemplifying a case where the reset transistor 64 common to the FD 63-1 and the FD 63-2.

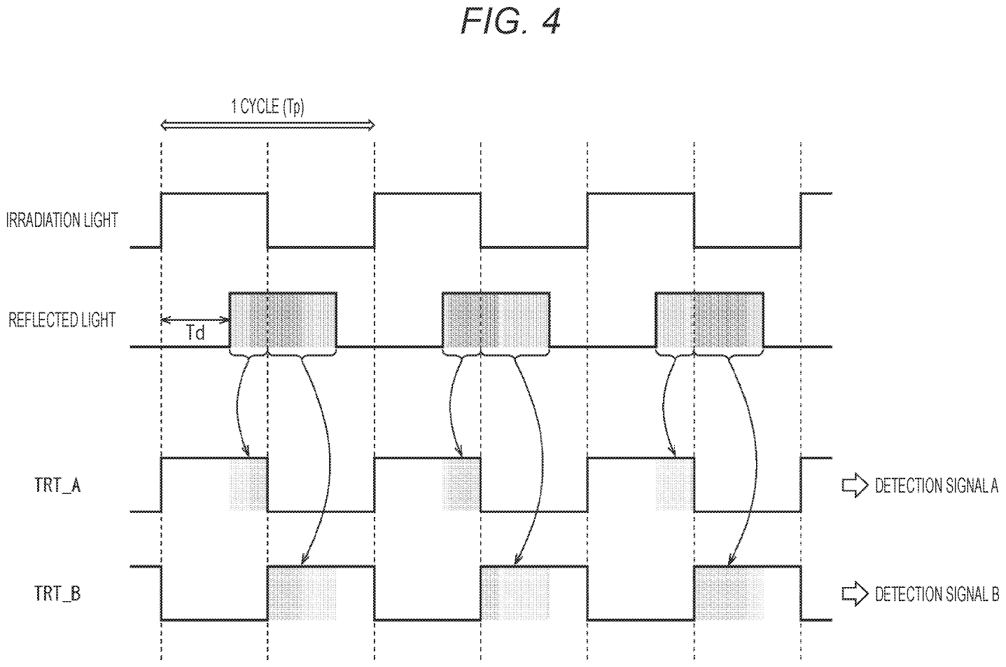

The distribution of charge in the pixel 50 will be described with reference to FIG. 4. Here, the distribution means that the charge accumulated in the pixel 50 (PD 61) is read out at different timings to perform the read-out for each tap.

As illustrated in FIG. 4, irradiation light modulated (1 cycle=Tp) so as to repeat on/off of emission in an irradiation time is output from the light emitting unit 14, and the reflected light is received by the PD 61 with a delay of a delay time Td corresponding to the distance to the object.

A transfer control signal TRT_A controls on/off of the transfer transistor 62-1, and a transfer control signal TRT_B controls on/off of the transfer transistor 62-2. As illustrated in the drawing, the transfer control signal TRT_A has the same phase as the irradiation light, whereas the transfer control signal TRT_B has a phase obtained by inverting the phase of the transfer control signal TRT_A.

Therefore, charge generated when the photodiode 61 receives the reflected light is transferred to the FD unit 63-1 while the transfer transistor 62-1 is turned on according to the transfer control signal TRT_A. Furthermore, charge is transferred to the FD unit 63-2 while the transfer transistor 62-2 is turned on according to the transfer control signal TRT_B. Therefore, during a predetermined period in which the irradiation with the irradiation light for the irradiation time T is periodically performed, the charge transferred via the transfer transistor 62-1 is sequentially accumulated in the FD unit 63-1, and the charge transferred via the transfer transistor 62-2 is sequentially accumulated in the FD unit 63-2.

Then, when the selection transistor 66-1 is turned on according to a selection signal SELm1 after the end of the period in which the charge is accumulated, the charge accumulated in the FD unit 63-1 is read out via the vertical signal line 47-1, and a detection signal A corresponding to an amount of the charge is output from the light receiving unit 12. Similarly, when the selection transistor 66-2 is turned on according to a selection signal SELm2, the charge accumulated in the FD unit 63-2 is read out via the vertical signal line 47-2, and a detection signal B corresponding to an amount of the charge is output from the light receiving unit 12.

The charge accumulated in the FD unit 63-1 is discharged when the reset transistor 64 is turned on according to a reset signal RST. Similarly, the charge accumulated in the FD unit 63-2 is discharged when the reset transistor 64 is turned on according to a reset signal RST A.

In this manner, the pixel 50 can distribute the charge, generated from the reflected light received by the photodiode 61, to the taps 51-1 and 51-2 according to the delay time Td, and output the detection signal A and the detection signal B. Then, the delay time Td corresponds to the time required by light emitted from the light emitting unit 14 to travel to the object and return to the light receiving unit 12 after being reflected from the object, that is, corresponds to the distance to the object. Therefore, the two-dimensional distance measuring sensor 10 can obtain the distance (depth) to the object according to the delay time Td on the basis of the detection signal A and the detection signal B.

<4. Regarding Flying Pixel>

Erroneous detection occurring near an edge of an object in an environment set as a distance measurement target will be described. Erroneously detected pixel occurring near the edge of the object may be referred to as a flying pixel, for example.

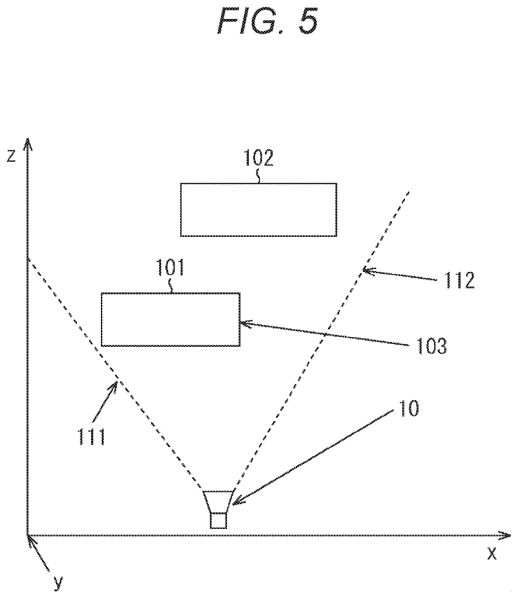

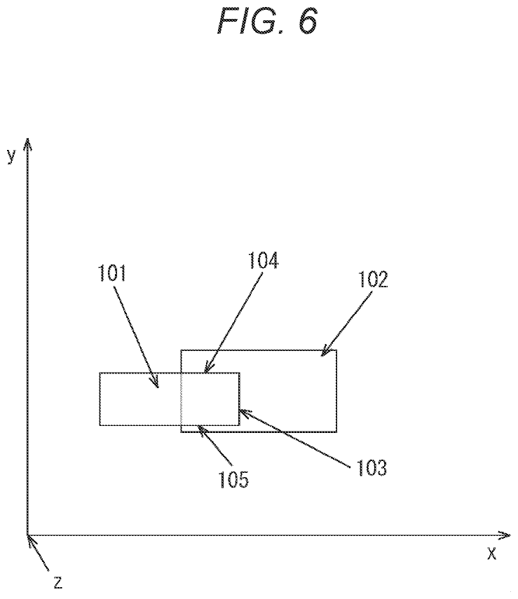

As illustrated in FIGS. 5 and 6, a case where there are two objects (objects) in a three-dimensional environment, and positions of the two objects are measured by the two-dimensional distance measuring sensor 10 will be considered. FIG. 5 is a view illustrating a positional relationship between a foreground object 101 and a background object 102 on an xz plane, and FIG. 6 is a view illustrating a positional relationship between the foreground object 101 and the background object 102 on an xy plane.

The xz plane illustrated in FIG. 5 is a plane when the foreground object 101, the background object 102, and the two-dimensional distance measuring sensor 10 are viewed from above, and the xy plane illustrated in FIG. 6 is a plane located in a direction perpendicular to the xz plane and is a plane when the foreground object 101 and the background object 102 are viewed from the two-dimensional distance measuring sensor 10.

Referring to FIG. 5, when the two-dimensional distance measuring sensor 10 is used as a reference, the foreground object 101 is located on a side close to the two-dimensional distance measuring sensor 10, and the background object 102 is located on a side far from the two-dimensional distance measuring sensor 10. Furthermore, the foreground object 101 and the background object 102 are located within the angle of view of the two-dimensional distance measuring sensor 10. The angle of view of the two-dimensional distance measuring sensor 10 is indicated by a dotted line 111 and a dotted line 112 in FIG. 5.

One edge of the foreground object 101, that is, a right edge in FIG. 5 is set as an edge 103. There is a possibility that a flying pixel occurs near this edge 103.

Referring to FIG. 6, the two-dimensional distance measuring sensor 10 captures an image in a state where the foreground object 101 and the background object 102 overlap. In such a case, there is a possibility that a flying pixel also occurs on an upper edge (set as an edge 104) of the foreground object 101 and a lower edge (set as an edge 105) of the foreground object 101.

In this case, the flying pixel is a pixel detected as a pixel belonging to an edge portion of the foreground object 101 or a pixel detected as a distance to neither the foreground object 101 nor the background object 102.

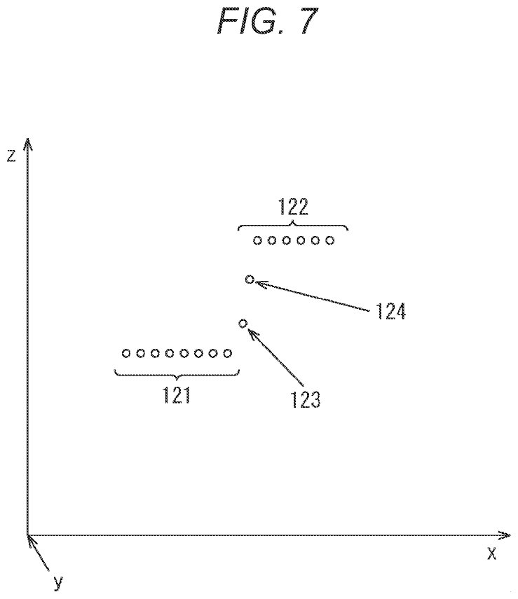

FIG. 7 is a view illustrating the foreground object 101 and the background object 102 by pixels corresponding to the image illustrated in FIG. 5. A pixel group 121 corresponds to pixels detected from the foreground object 101, and a pixel group 122 corresponds to pixels detected from the background object 102. A pixel 123 and a pixel 124 are flying pixels and are erroneously detected pixels.

The pixel 123 and the pixel 124 are located on an edge between the foreground object 101 and the background object 102 as illustrated in FIG. 7. There is a possibility that all these flying pixels belong to the foreground object 101 or the background object 102, or there is a possibility that only one of these belongs to the foreground object 101 and the other belongs to the background object 102.

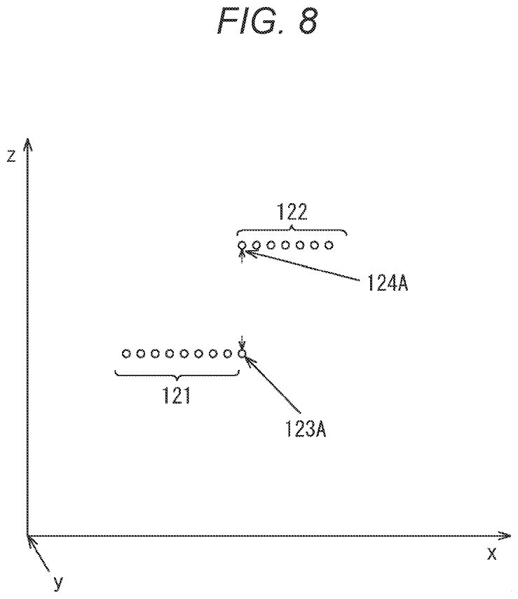

The pixel 123 and the pixel 124 are detected as the flying pixels and appropriately processed to be corrected as illustrated in FIG. 8, for example. Referring to FIG. 8, the pixel 123 (FIG. 7) is modified to a pixel 123A belonging to the pixel group 121 that belongs to the foreground object 101, and the pixel 123 (FIG. 7) is corrected to a pixel 124A belonging to the pixel group 122 that belongs to the background object 102.

<5. Processing Related to Detection of Flying Pixel>

The filter unit 16 in FIG. 1 detects a flying pixel. The filter unit 16 receives the distance measurement information including the depth map supplied from the signal processing unit 13 of the two-dimensional distance measuring sensor 10, and captured image information including the image signal supplied from the signal processing unit 22 of the two-dimensional image sensor 20. The filter unit 16 detects a correction target pixel such as a flying pixel from the depth map (group of pixels) on the basis of a correlation between the distance measurement information and the captured image information. Details of the correlation between the distance measurement information and the captured image information will be described later.

Furthermore, the filter unit 16 corrects information of a correction target pixel portion in the depth map by performing interpolation or level adjustment from surrounding information having a high correlation using a processor or a signal processing circuit. The filter unit 16 can generate and output the depth map using the corrected pixel.

<6. Application Example Using AI>

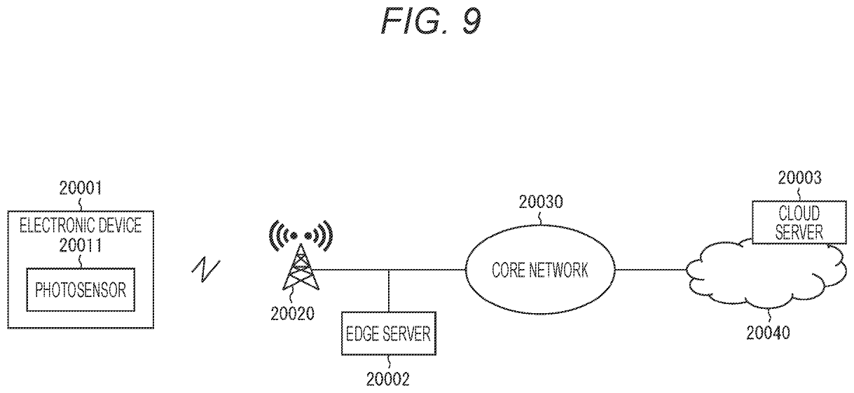

In a configuration to which the technology according to the present disclosure (the present technology) is applied, artificial intelligence (AI) such as machine learning can be used. FIG. 9 illustrates a configuration example of a system including a device that performs AI processing.

An electronic device 20001 is a mobile terminal such as a smartphone, a tablet terminal, or a mobile phone. The electronic device 20001 includes an optical sensor 20011 to which the technology according to the present disclosure is applied. The optical sensor 20011 is a sensor (image sensor) that converts light into an electric signal. The electronic device 20001 can be connected to a network 20040 such as the Internet via a core network 20030 by being connected to a base station 20020 installed at a predetermined place by wireless communication corresponding to a predetermined communication method.

At a position closer to the mobile terminal, such as between the base station 20020 and the core network 20030, an edge server 20002 is provided to implement mobile edge computing (MEC). A cloud server 20003 is connected to the network 20040. The edge server 20002 and the cloud server 20003 can perform various types of processing according to the purpose. Note that the edge server 20002 may be provided in the core network 20030.

AI processing is performed by the electronic device 20001, the edge server 20002, the cloud server 20003, or the optical sensor 20011. The AI processing is processing the technology according to the present disclosure using AI such as machine learning. The AI processing includes learning processing and inference processing. The learning processing is processing of generating a learning model. Furthermore, the learning processing also includes relearning processing as described later. The inference processing is processing of performing inference using a learning model. Hereinafter, processing related to the technology according to the present disclosure and set as processing that does not use AI is referred to as normal processing and is distinguished from the AI processing.

In the electronic device 20001, the edge server 20002, the cloud server 20003, or the optical sensor 20011, a processor such as a central processing unit (CPU) executes a program or dedicated hardware such as a processor specialized for a specific purpose is used to implement AI processing. For example, a graphics processing unit (GPU) can be used as a processor specialized for a specific purpose.

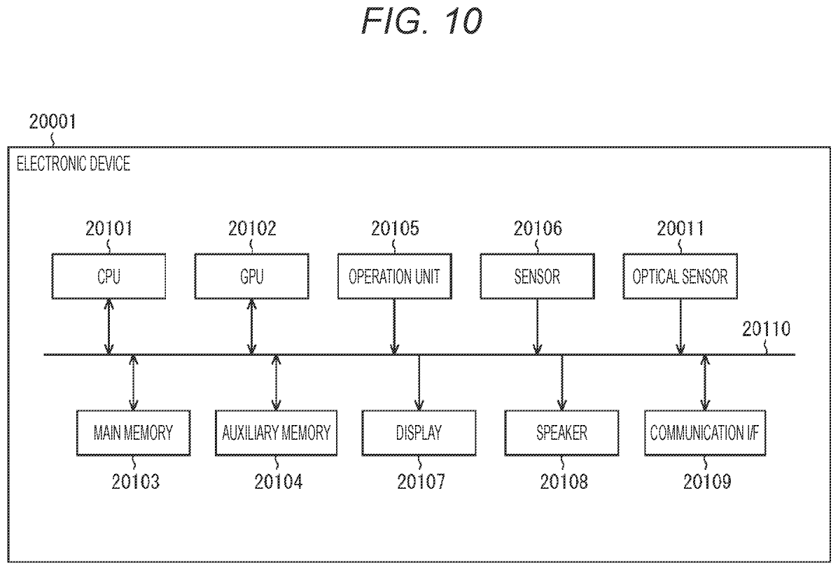

FIG. 10 illustrates a configuration example of the electronic device 20001. The electronic device 20001 includes a CPU 20101 that controls operation of each unit and performs various types of processing, a GPU 20102 specialized for image processing and parallel processing, a main memory 20103 such as a dynamic random access memory (DRAM), and an auxiliary memory 20104 such as a flash memory.

The auxiliary memory 20104 records programs for AI processing and data such as various parameters. The CPU 20101 loads the programs and parameters recorded in the auxiliary memory 20104 into the main memory 20103 and executes the programs. Alternatively, the CPU 20101 and the GPU 20102 develop programs and parameters recorded in the auxiliary memory 20104 in the main memory 20103 and execute the programs. Therefore, the GPU 20102 can be used as a general-purpose computing on graphics processing units (GPGPU).

Note that the CPU 20101 and the GPU 20102 may be configured as a system on a chip (SoC). In a case where the CPU 20101 executes programs for AI processing, the GPU 20102 may not be provided.

The electronic device 20001 also includes the optical sensor 20011 to which the technology according to the present disclosure is applied, an operation unit 20105 such as a physical button or a touch panel, a sensor 20106 including at least one or more sensors, a display 20107 that displays information such as an image or text, a speaker 20108 that outputs sound, a communication I/F 20109 such as a communication module compatible with a predetermined communication method, and a bus 20110 that connects them.

The sensor 20106 includes at least one or more sensors of various sensors such as an optical sensor (image sensor), a sound sensor (microphone), a vibration sensor, an acceleration sensor, an angular velocity sensor, a pressure sensor, an odor sensor, and a biometric sensor. In the AI processing, data acquired from at least one or more sensors of the sensor 20106 can be used together with image data (distance measurement information) acquired from the optical sensor 20011. Since the data obtained from various sensors is used together with the image data in this manner, the AI processing suitable for various scenes can be implemented by the multi-modal AI technology.

Note that data acquired from two or more optical sensors by the sensor fusion technology and data obtained by integrally processing the data may be used in the AI processing. As the two or more optical sensors, a combination of the optical sensor 20011 and the optical sensor in the sensor 20106 may be used, or a plurality of optical sensors may be included in the optical sensor 20011. For example, the optical sensor includes an RGB visible light sensor, a distance measuring sensor such as time of flight (ToF), a polarization sensor, an event-based sensor, a sensor that acquires an IR image, a sensor capable of acquiring multiple wavelengths, and the like.

The two-dimensional distance measuring sensor 10 in FIG. 1 is applied to the optical sensor 20011 of the embodiment. For example, the optical sensor 20011 can measure a distance to a target object and output a depth value of a surface shape of the target as a distance measurement result.

Furthermore, the two-dimensional image sensor 20 in FIG. 1 is applied as the sensor 20106. For example, the two-dimensional image sensor 20 is an RGB visible light sensor, and can receive visible light having RGB wavelengths and output an image signal of a subject as image information. Furthermore, the two-dimensional image sensor 20 may have a function as a polarization sensor. In such a case, the two-dimensional image sensor 20 can generate a polarization image signal based on light polarized in a predetermined polarization direction by a polarizing filter and output the polarization image signal as polarization direction image information. In the AI processing of the embodiment, data acquired from the two-dimensional distance measuring sensor 10 and the two-dimensional image sensor 20 is used.

In the electronic device 20001, the AI processing can be performed by a processor such as the CPU 20101 or the GPU 20102. In a case where the processor of the electronic device 20001 performs the inference processing, the processing can be started without requiring time after the distance measurement information is acquired by the optical sensor 20011, and thus, the processing can be performed at high speed. Therefore, in the electronic device 20001, when the inference processing is used for a purpose such as an application required to transmit information with a short delay time, the user can perform an operation without feeling uncomfortable due to the delay. Furthermore, in a case where the processor of the electronic device 20001 performs AI processing, it is not necessary to use a communication line, a computer device for a server, or the like, and the processing can be implemented at low cost, as compared with a case where a server such as the cloud server 20003 is used.

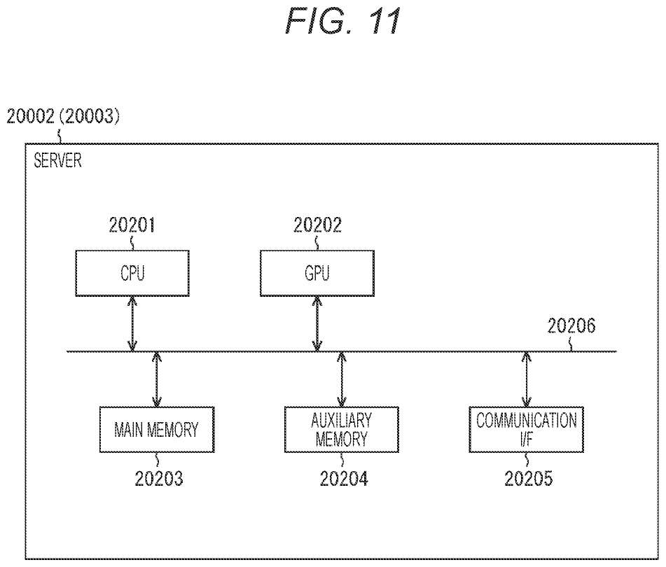

FIG. 11 illustrates a configuration example of the edge server 20002. The edge server 20002 includes a CPU 20201 that controls operation of each unit and performs various types of processing, and a GPU 20202 specialized for image processing and parallel processing. The edge server 20002 further includes a main memory 20203 such as a DRAM, an auxiliary memory 20204 such as a hard disk drive (HDD) or a solid state drive (SSD), and a communication I/F 20205 such as a network interface card (NIC), which are connected to the bus 20206.

The auxiliary memory 20204 records programs for the AI processing and data such as various parameters. The CPU 20201 loads the programs and parameters recorded in the auxiliary memory 20204 into the main memory 20203 and executes the programs. Alternatively, the CPU 20201 and the GPU 20202 can develop programs or parameters recorded in the auxiliary memory 20204 in the main memory 20203 and execute the programs, whereby the GPU 20202 is used as a GPGPU. Note that, in a case where the CPU 20201 executes programs for AI processing, the GPU 20202 may not be provided.

In the edge server 20002, the AI processing can be performed by a processor such as the CPU 20201 or the GPU 20202. In a case where the processor of the edge server 20002 performs the AI processing, since the edge server 20002 is provided at a position closer to the electronic device 20001 than the cloud server 20003, it is possible to realize low processing delay. Furthermore, the edge server 20002 has higher processing capability, such as a calculation speed, than the electronic device 20001 and the optical sensor 20011, and thus, can be configured in a general-purpose manner. Therefore, in a case where the processor of the edge server 20002 performs AI processing, the AI processing can be performed as long as data can be received regardless of a difference in specifications or performance between the electronic device 20001 and the optical sensor 20011. In a case where the AI processing is performed by the edge server 20002, a processing load in the electronic device 20001 and the optical sensor 20011 can be reduced.

Since the configuration of the cloud server 20003 is similar to the configuration of the edge server 20002, the description thereof will be omitted.

In the cloud server 20003, AI processing can be performed by a processor such as the CPU 20201 or the GPU 20202. The cloud server 20003 has higher processing capability, such as calculation speed, than the electronic device 20001 and the optical sensor 20011, and thus, can be configured in a general-purpose manner. Therefore, in a case where the processor of the cloud server 20003 performs AI processing, the AI processing can be performed regardless of a difference in specifications and performance between the electronic device 20001 and the optical sensor 20011. Furthermore, in a case where it is difficult for the processor of the electronic device 20001 or the optical sensor 20011 to perform high-load AI processing, the processor of the cloud server 20003 can perform the high-load AI processing, and a result of the processing can be fed back to the processor of the electronic device 20001 or the optical sensor 20011.

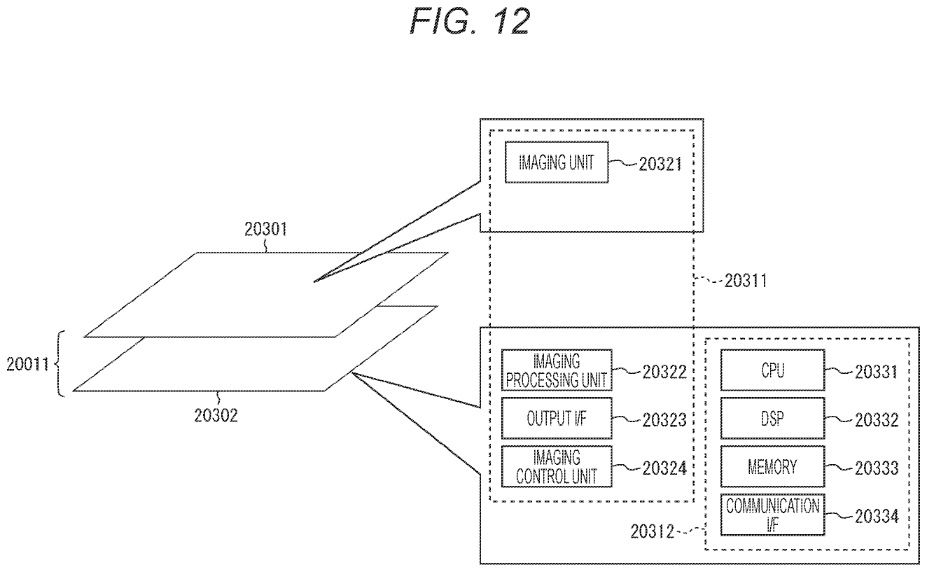

FIG. 12 illustrates a configuration example of the optical sensor 20011. The optical sensor 20011 can be configured as, for example, a one-chip semiconductor device having a stacked structure in which a plurality of substrates is stacked. The optical sensor 20011 is configured by stacking two substrates of a substrate 20301 and a substrate 20302. Note that the configuration of the optical sensor 20011 is not limited to the stacked structure, and for example, a substrate including an imaging unit may include a processor that performs AI processing such as a CPU or a digital signal processor (DSP).

An imaging unit 20321 including a plurality of pixels two-dimensionally arranged is mounted on the upper substrate 20301. An imaging processing unit 20322 that performs processing related to imaging of an image by the imaging unit 20321, an output I/F 20323 that outputs a captured image and a signal processing result to the outside, and an imaging control unit 20324 that controls imaging of an image by the imaging unit 20321 are mounted on the lower substrate 20302. The imaging unit 20321, the imaging processing unit 20322, the output I/F 20323, and the imaging control unit 20324 constitute an imaging block 20311.

When the two-dimensional distance measuring sensor 10 in FIG. 1 is applied to the optical sensor 20011, for example, the imaging unit 20321 corresponds to the light receiving unit 12, and the imaging processing unit 20322 corresponds to the signal processing unit 13.

A CPU 20331 that performs control of each unit and various types of processing, a DSP 20332 that performs signal processing using a captured image, information from the outside, and the like, a memory 20333 such as a static random access memory (SRAM) or a dynamic random access memory (DRAM), and a communication I/F 20334 that exchanges necessary information with the outside are mounted on the lower substrate 20302. The CPU 20331, the DSP 20332, the memory 20333, and the communication I/F 20334 constitute a signal processing block 20312. The AI processing can be performed by at least one processor of the CPU 20331 or the DSP 20332.

In this manner, the signal processing block 20312 for AI processing can be mounted on the lower substrate 20302 in the stacked structure in which the plurality of substrates is stacked. Therefore, the distance measurement information acquired by the imaging block 20311 for imaging, mounted on the upper substrate 20301, is processed by the signal processing block 20312 for AI processing mounted on the lower substrate 20302, so that a series of processing can be performed in the one-chip semiconductor device.

When the two-dimensional distance measuring sensor 10 of FIG. 1 is applied to the optical sensor 20011, for example, the signal processing block 20312 corresponds to the filter unit 16.

In the optical sensor 20011, AI processing can be performed by a processor such as the CPU 20331. In a case where the processor of the optical sensor 20011 performs AI processing such as inference processing, since a series of processing is performed in the one-chip semiconductor device, information does not leak to the outside of the sensor, and thus, it is possible to enhance confidentiality of the information. Furthermore, since it is unnecessary to transmit data such as distance measurement information to another device, the processor of the optical sensor 20011 can perform AI processing such as inference processing using the distance measurement information at high speed. For example, when inference processing is used for a purpose such as an application requiring a real-time property, it is possible to sufficiently secure the real-time property. Here, securing the real-time property means that information can be transmitted with a short delay time. Moreover, when the processor of the optical sensor 20011 performs the AI processing, various types of metadata are passed by the processor of the electronic device 20001, so that the processing can be reduced and the power consumption can be reduced.

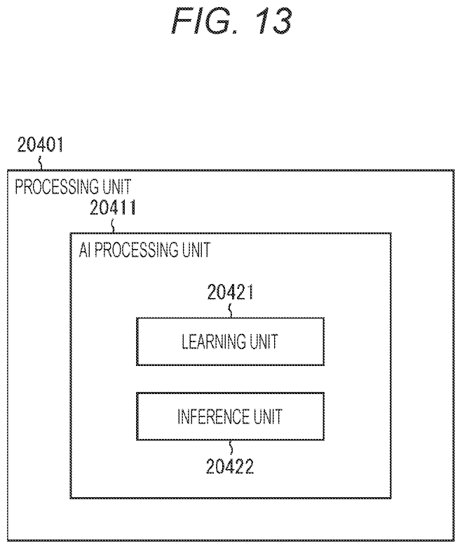

FIG. 13 illustrates a configuration example of a processing unit 20401. The processor of the electronic device 20001, the edge server 20002, the cloud server 20003, or the optical sensor 20011 executes various types of processing according to programs, thereby functioning as the processing unit 20401. Note that a plurality of processors included in the same or different devices may function as the processing unit 20401.

The processing unit 20401 includes an AI processing unit 20411. The AI processing unit 20411 performs AI processing. The AI processing unit 20411 includes a learning unit 20421 and an inference unit 20422.

The learning unit 20421 performs learning processing of generating a learning model. In the learning processing, a machine-learned learning model obtained by performing machine learning for correcting a correction target pixel included in distance measurement information is generated. Furthermore, the learning unit 20421 may perform relearning processing of updating the generated learning model. In the following description, generation and update of the learning model will be described separately, but since it can be said that the learning model is generated by updating the learning model, the generation of the learning model includes the meaning of the update of the learning model.

Furthermore, the generated learning model is recorded in a storage medium such as a main memory or an auxiliary memory included in the electronic device 20001, the edge server 20002, the cloud server 20003, the optical sensor 20011, or the like, and thus, can be newly used in the inference processing performed by the inference unit 20422. Therefore, the electronic device 20001, the edge server 20002, the cloud server 20003, the optical sensor 20011, or the like that performs inference processing based on the learning model can be generated. Moreover, the generated learning model may be recorded in a storage medium or electronic device independent of the electronic device 20001, the edge server 20002, the cloud server 20003, the optical sensor 20011, or the like, and provided for use in other devices. Note that the generation of the electronic device 20001, the edge server 20002, the cloud server 20003, the optical sensor 20011, or the like includes not only newly recording the learning model in the storage medium at the time of manufacturing but also updating the already recorded generated learning model.

The inference unit 20422 performs inference processing using the learning model. In the inference processing, processing for correcting a correction target pixel included in distance measurement information is performed using the learning model. The correction target pixel is a pixel that satisfies a predetermined condition and is set as a correction target among a plurality of pixels in an image corresponding to the distance measurement information.

As a method of machine learning, a neural network, deep learning, or the like can be used. The neural network is a model imitating a human cranial nerve circuit, and includes three types of layers of an input layer, an intermediate layer (hidden layer), and an output layer. Deep learning is a model using a neural network having a multilayer structure, and can learn a complex pattern hidden in a large amount of data by repeating characteristic learning in each layer.

Supervised learning can be used as the problem setting of the machine learning. For example, supervised learning learns a feature amount on the basis of given labeled teacher data. Therefore, it is possible to derive a label of unknown data. As the teacher data, distance measurement information actually acquired by the optical sensor, acquired distance measurement information that is aggregated and managed, a data set generated by a simulator, and the like can be used.

Note that not only supervised learning but also unsupervised learning, semi-supervised learning, reinforcement learning, and the like may be used. In the unsupervised learning, a large amount of unlabeled learning data is analyzed to extract a feature amount, and clustering or the like is performed on the basis of the extracted feature amount. Therefore, it is possible to analyze and predict the tendency on the basis of a huge amount of unknown data. The semi-supervised learning is a method in which supervised learning and unsupervised learning are mixed, and is a method in which a feature amount is learned by the supervised learning, then a huge amount of teacher data is given by the unsupervised learning, and repetitive learning is performed while the feature amount is automatically calculated. The reinforcement learning deals with a problem of determining an action that an agent in a certain environment should take by observing a current state.

As described above, the processor of the electronic device 20001, the edge server 20002, the cloud server 20003, or the optical sensor 20011 functions as the AI processing unit 20411, so that the AI processing is performed by any one or a plurality of devices out of these devices.

The AI processing unit 20411 only needs to include at least one of the learning unit 20421 or the inference unit 20422. That is, the processor of each device may execute one of the learning processing or the inference processing as well as execute both the learning processing and the inference processing. For example, in a case where the processor of the electronic device 20001 performs both the inference processing and the learning processing, the learning unit 20421 and the inference unit 20422 are included, but in a case where only the inference processing is performed, only the inference unit 20422 may be included.

The processor of each device may execute all processes related to the learning processing or the inference processing, or may execute some processes by the processor of each device and then execute the remaining processes by the processor of another device. Furthermore, each device may have a common processor for executing each function of AI processing such as learning processing or inference processing, or may have a processor individually for each function.

Note that the AI processing may be performed by a device other than the above-described devices. For example, AI processing can be performed by another electronic device to which the electronic device 20001 can be connected by wireless communication or the like. Specifically, in a case where the electronic device 20001 is a smartphone, the other electronic device that performs the AI processing can be a device such as another smartphone, a tablet terminal, a mobile phone, a personal computer (PC), a game machine, a television receiver, a wearable terminal, a digital still camera, or a digital video camera.

Furthermore, even in a configuration using a sensor mounted on a moving body such as an automobile, a sensor used in a remote medical device, or the like, AI processing such as inference processing can be applied, but a delay time is required to be short in these environments. In such an environment, the delay time can be shortened by not performing the AI processing by the processor of the cloud server 20003 via the network 20040 but performing the AI processing by the processor of a local-side device (for example, the electronic device 20001 as the in-vehicle device or the medical device). Moreover, even in a case where there is no environment to connect to the network 20040 such as the Internet or in a case of a device used in an environment in which high-speed connection cannot be performed, AI processing can be performed in a more appropriate environment by performing AI processing by the processor of the local-side device such as the electronic device 20001 or the optical sensor 20011, for example.

Note that the above-described configuration is an example, and other configurations may be adopted. For example, the electronic device 20001 is not limited to the mobile terminal such as a smartphone, and may be an electronic device such as a PC, a game machine, a television receiver, a wearable terminal, a digital still camera, or a digital video camera, an industrial device, an in-vehicle device, or a medical device. Furthermore, the electronic device 20001 may be connected to the network 20040 by wireless communication or wired communication corresponding to a predetermined communication method such as a wireless local area network (LAN) or a wired LAN. The AI processing is not limited to a processor such as a CPU or a GPU of each device, and a quantum computer, a neuromorphic computer, or the like may be used.

<7. Flow of Processing Using AI>

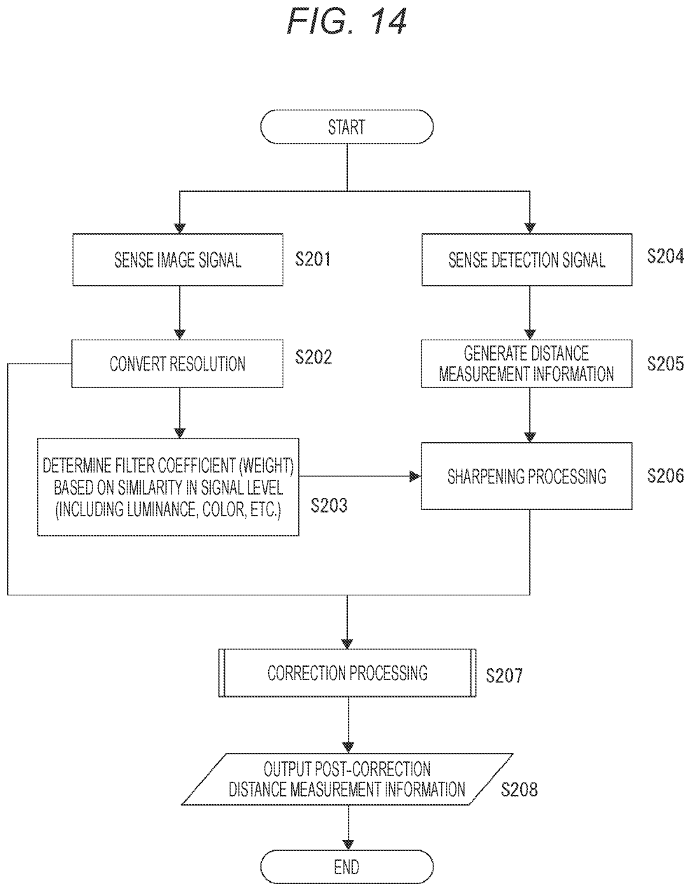

A flow of processing using AI will be described with reference to a flowchart of FIG. 14.

First, distance measurement information and captured image information are acquired by processing from steps S201 to S206. Specifically, sensing of an image signal of each pixel in the sensor 20106 (two-dimensional image sensor 20 in FIG. 1) is performed in step S201, and resolution conversion is performed on the image signal obtained by the sensing to generate the captured image information in step S202. The captured image information here is a signal obtained by photoelectrically converting visible light having a wavelength of R, G, or B, but may also be a G signal level map indicating G signal level distribution.

In the resolution conversion described above, it is assumed that the spatial resolving power (the number of pixels) of the sensor 20106 (two-dimensional image sensor 20) is higher than that of the optical sensor 20011 (two-dimensional distance measuring sensor 10), and an oversampling effect obtained by resolution conversion for reducing the spatial resolving power of the two-dimensional image sensor 20 to correspond to that of the two-dimensional distance measuring sensor 10, that is, an effect of restoring a frequency component higher than that defined by the Nyquist frequency is expected. Therefore, a sense of resolution superior to that of the two-dimensional distance measuring sensor 10 can be obtained even if the actual number of pixels is the same resolving power as that of the two-dimensional distance measuring sensor 10, and an effect of reducing a sense of noise of a flat portion can be obtained by a noise reduction effect due to the reduction.

After the resolution is converted in step S202, a filter coefficient (weight) based on a signal level (including luminance, a color, or the like) of the image signal is determined in step S203. When the resolution conversion processing is actively utilized, it is possible to obtain a filter coefficient suitable for sharpening processing of the distance measurement information as described later.

On the other hand, in step S204, sensing of a detection signal of each pixel in the sensor 20106 (two-dimensional distance measuring sensor 10) is performed, and the distance measurement information (depth map) is generated on the basis of the detection signal obtained by the sensing in step S205. Furthermore, the distance measurement information generated in step S203 is subjected to the sharpening processing using the determined filter coefficient.

Through the processing from steps S201 to S206 described above, the processing unit 20401 acquires the captured image information from the sensor 20106 and the distance measurement information subjected to the sharpening processing from the optical sensor 20011.

In step S207, the processing unit 20401 receives inputs of the distance measurement information and the captured image information and performs correction processing on the acquired distance measurement information. In this correction processing, inference processing using a learning model is performed for at least a part of the distance measurement information, and post-correction distance measurement information (post-correction depth map), which is distance measurement information after correction of a correction target pixel included in the distance measurement information, is obtained. In step S208, the processing unit 20401 outputs the post-correction distance measurement information (post-correction depth map) obtained by the correction processing.

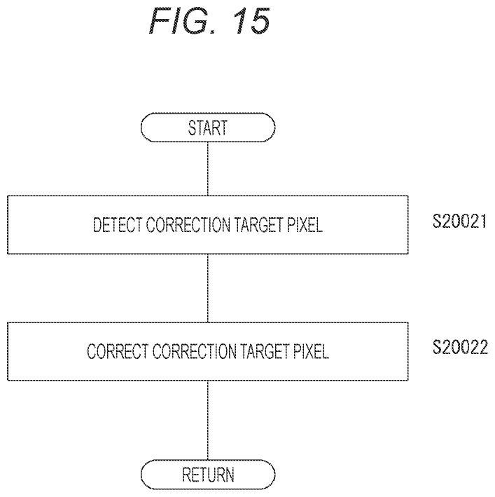

Here, details of the correction processing in step S207 described above will be described with reference to a flowchart of FIG. 15.

In step S20021, the processing unit 20401 detects the correction target pixel included in the distance measurement information. In this step (hereinafter, referred to as detection step) of detecting the correction target pixel, inference processing or normal processing is performed.

In a case where the inference processing is performed as the detection step, the distance measurement information and the captured image information are input to a learning model so that information (hereinafter, referred to as detection information) for detecting the correction target pixel included in the input distance measurement information is output in the inference unit 20422, and thus, the correction target pixel can be detected. Here, the learning model, which receives inputs of the captured image information and the distance measurement information including the correction target pixel and outputs the detection information of the correction target pixel included in the distance measurement information, is used. On the other hand, in a case where the normal processing is performed as the detection step, processing of detecting the correction target pixel included in the distance measurement information is performed by the processor or the signal processing circuit of the electronic device 20001 or the optical sensor 20011 without using AI.

When the correction target pixel included in the distance measurement information is detected in step S20021, the processing proceeds to step S20022. In step S20022, the processing unit 20401 corrects the detected correction target pixel. In the step (hereinafter, referred to as correction step) of correcting the correction target pixel, inference processing or normal processing is performed.

In a case where the inference processing is performed as the correction step, the distance measurement information and the detection information of the correction target pixel are input to a learning model so that corrected distance measurement information (post-correction distance measurement information) or the corrected detection information of the correction target pixel is output in the inference unit 20422, and thus, the correction target pixel can be corrected. Here, the learning model, which receives inputs of the distance measurement information including the correction target pixel and the detection information of the correction target pixel and outputs the corrected distance measurement information (post-correction distance measurement information) or the corrected detection information of the correction target pixel, is used. On the other hand, in a case where the normal processing is performed as the correction step, processing of correcting the correction target pixel included in the distance measurement information is performed by the processor or the signal processing circuit of the electronic device 20001 or the optical sensor 20011 without using AI.

In this manner, in the correction processing illustrated in FIG. 15, the inference processing or the normal processing is performed in the detection step of detecting the correction target pixel, and the inference processing or the normal processing is performed in the correction step of correcting the detected correction target pixel, so that the inference processing is performed in at least one step of the detection step or the correction step. That is, in the correction processing, the inference processing using the learning model is performed for at least a part of the distance measurement information from the optical sensor 20011.

Furthermore, in the correction processing, the detection step may be performed integrally with the correction step by using the inference processing. In a case where the inference processing is performed as such a correction step, the distance measurement information and the captured image information are input to a learning model so that the post-correction distance measurement information in which the correction target pixel has been corrected is output in the inference unit 20422, and thus, the correction target pixel included in the input distance measurement information can be corrected. Here, the learning model, which receives inputs of the captured image information and the distance measurement information including the correction target pixel and outputs the post-correction distance measurement information in which the correction target pixel has been corrected, is used.

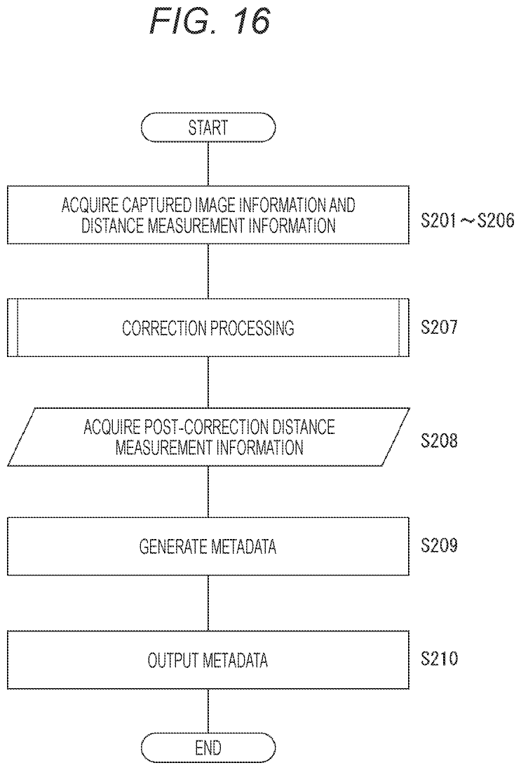

The processing unit 20401 may generate metadata using the post-correction distance measurement information (post-correction depth map). A flowchart of FIG. 16 illustrates a flow of processing in a case where the metadata is to be generated.

In the processing of FIG. 16, similarly to FIG. 14, the processing unit 20401 acquires distance measurement information and captured image information in steps S201 to S206, and correction processing using the distance measurement information and the captured image information is performed in step S207. In step S208, the processing unit 20401 acquires post-correction distance measurement information by the correction processing. In step S209, the processing unit 20401 generates metadata using the post-correction distance measurement information (post-correction depth map) obtained in the correction processing. In a step (hereinafter, referred to as generation step) of generating the metadata, inference processing or normal processing is performed. In step S210, the processing unit 20401 outputs the generated metadata.

In a case where the inference processing is performed as the generation step, the post-correction distance measurement information is input to a learning model so that the metadata regarding the input post-correction distance measurement information is output in the inference unit 20422, and thus, the metadata can be generated. Here, the learning model, which receives an input of corrected data and outputs the metadata, is used. For example, the metadata includes three-dimensional data such as a point cloud and a data structure. Note that the processing in steps S201 to S209 may be performed by end-to-end machine learning. On the other hand, in a case where the normal processing is performed as the generation step, processing of generating the metadata from the corrected data is performed by the processor or the signal processing circuit of the electronic device 20001 or the optical sensor 20011 without using AI.

As described above, in the electronic device 20001, the edge server 20002, the cloud server 20003, or the optical sensor 20011, as the correction processing using the distance measurement information from the optical sensor 20011 and the captured image information from the sensor 20106,
the detection step of detecting the correction target pixel and the correction step of correcting the correction target pixel are performed, or the correction step of correcting the correction target pixel included in the distance measurement information is performed. Moreover, the electronic device 20001, the edge server 20002, the cloud server 20003, or the optical sensor 20011 can perform the generation step of generating the metadata using the post-correction distance measurement information obtained by the correction processing.

Furthermore, when these pieces of data such as the post-correction distance measurement information and the metadata are stored in a readable storage medium, it is also possible to generate a storage medium in which these pieces of data are recorded or a device such as an electronic device on which the storage medium is mounted. The storage medium may be a storage medium such as a main memory or an auxiliary memory provided in the electronic device 20001, the edge server 20002, the cloud server 20003, or the optical sensor 20011, or may be a storage medium or an electronic device independent of them.

In a case where the detection step, the correction step, and the generation step are performed in the correction processing, the inference processing using the learning model can be performed in at least one step of the detection step, the correction step, and the generation step. Specifically, the inference processing is performed in at least one step when the inference processing or the normal processing is performed in the correction step after the inference processing or the normal processing is performed in the detection step, and further, the inference processing or the normal processing is performed in the generating step.

Furthermore, in a case where only the correction step is performed in the correction processing, the inference processing can be performed in the correction step, and the inference processing or the normal processing can be performed in the generation step. Specifically, the inference processing is performed in at least one step when the inference processing or the normal processing is performed in the generation step after the inference processing is performed in the correction step.

In this manner, in the detection step, the correction step, and the generation step, the inference processing may be performed in all the steps, or the inference processing may be performed in some steps and the normal processing may be performed in the remaining steps. Hereinafter, in particular, processing in a case where the inference processing is performed in each step of the detection step and the correction step will be described.

(A) Processing in Case where Inference Processing is Performed in Detection Step

When inference processing is performed in a detection step in a case where the detection step and a correction step are performed in correction processing, the inference unit 20422 uses a learning model that receives inputs of the distance measurement information including the correction target pixel and the captured image information and outputs the position information of the correction target pixel included in the distance measurement information. This learning model is generated by learning processing using the learning unit 20421, is provided to the inference unit 20422, and is used when the inference processing is performed.

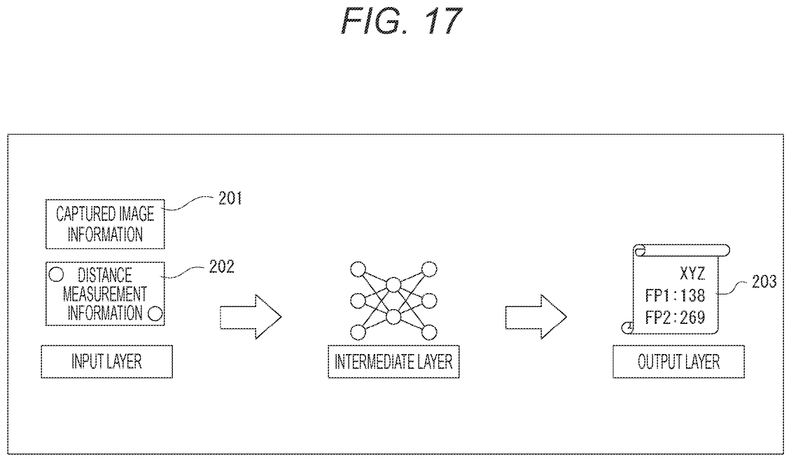

FIG. 17 illustrates an example of the learning model generated by the learning unit 20421. FIG. 17 illustrates a machine-learned learning model using a neural network including three layers of an input layer, an intermediate layer, and an output layer. The learning model is a learning model that receives inputs of captured image information 201 and distance measurement information 202 (a depth map including flying pixels as indicated by circles in the drawing) and outputs position information 203 of correction target pixels included in the input distance measurement information (coordinate information of the flying pixels included in the input depth map).

In the inference unit 20422, the learning model of FIG. 17 is used to perform an operation on the distance measurement information (depth map) including the flying pixels and the captured image information, input to the input layer, in the intermediate layer having parameters trained to detect any position of the flying pixel, and position information (detection information of the correction target pixels) of the flying pixels included in the input distance measurement information (depth map) is output from the output layer.

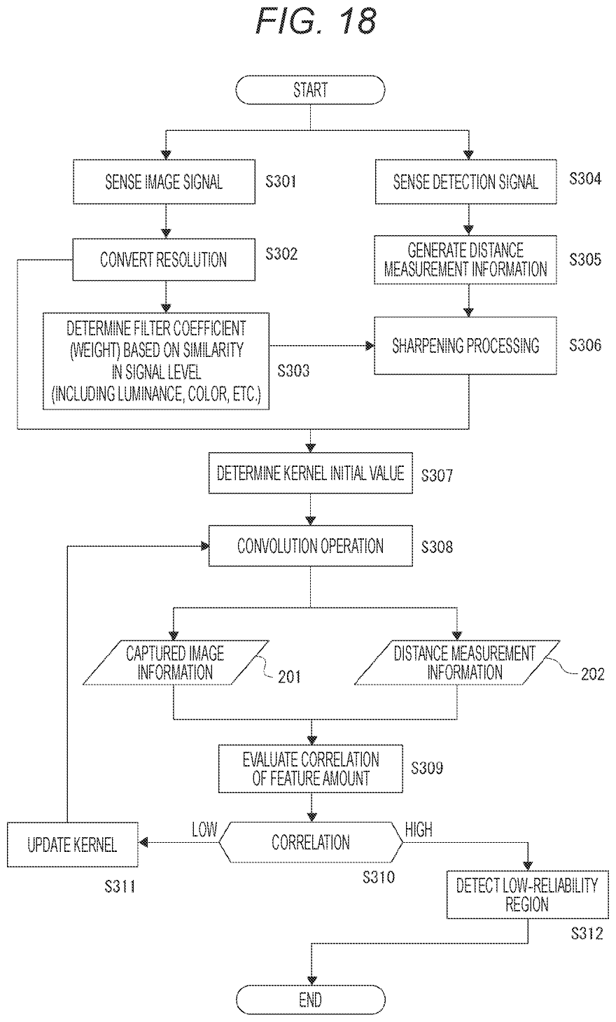

A flow of learning processing performed in advance when the inference processing is performed in the detection step in the case where the detection step and the correction step (S20021 and S20022 in FIG. 15) are performed in the correction processing illustrated in FIG. 14 will be described as follows with reference to a flowchart of FIG. 18.

First, in steps S301 to S306, similarly to steps S201 to S206 in FIG. 14, the captured image information 201 is generated by performing resolution conversion on an image signal obtained by sensing, and the distance measurement information 202 subjected to sharpening processing using a determined filter coefficient is generated. The learning unit 20421 acquires the generated captured image information 201 and distance measurement information 202.

In step S307, the learning unit 20421 determines an initial value of a kernel coefficient. The kernel coefficient is used to determine a correlation between the acquired captured image information 201 and the distance measurement information 202, and is a filter (for example, a Gaussian filter) suitable for sharpening edge (contour) information of the captured image information 201 and the distance measurement information (depth map) 202. The same kernel coefficient is applied to the captured image information 201 and the distance measurement information 202.

Thereafter, in steps S308 to S311, the correlation is evaluated while performing convolution of the kernel coefficient. That is, the learning unit 20421 performs the convolution operation of the kernel coefficient in step S308 through the processing in steps S309, S310, and S311 while obtaining the captured image information 201 and the distance measurement information 202 to which the kernel coefficient is applied.

In step S309, the learning unit 20421 evaluates a correlation in a feature amount of each of objects in an image on the basis of the obtained captured image information 201 and distance measurement information 202. That is, the learning unit 20421 recognizes the object (feature) from luminance and color distribution of the captured image information 201, and learns the correlation (similarity in in-plane tendency) between the feature and the distance measurement information 202 with reference to the captured image information 201 (in a case where the captured image information 201 is based on a G signal, an object (feature) is recognized from G signal level distribution). In such convolution and correlation evaluation processing, silhouette matching, contour fitting, and the like between the objects are performed. When the silhouette matching is performed, edge enhancement or smoothing processing (for example, convolution) is applied in order to improve the accuracy thereof.

As a result of the correlation evaluation, when it is determined in step S310 that the correlation is low, the evaluation result is fed back in step S311 to update the kernel coefficient.

Thereafter, the learning unit 20421 performs the processing from steps S308 to S309 on the basis of the updated kernel coefficient. The validity of the updated value of the kernel coefficient is recognized from a previous correlation. The learning unit 20421 updates the kernel coefficient in step 311 and repeatedly executes the processing from steps 308 to S310 until the correlation is determined to be valid in step S310, that is, until the optimized kernel coefficient which obtains the highest in-plane correlation between the captured image information 201 and the distance measurement information 202.

When the updated kernel coefficient is optimized in step S310, the learning unit 20421 advances the processing to step S312. In step S312, the learning unit 20421 detects a pixel of the distance measurement information 202 specifically separated from the captured image information 201 although the in-plane correlation is high as a correction target pixel (flying pixel) having low similarity to the captured image information 201. Then, the learning unit 20421 detects a region including one or a plurality of correction target pixels as a low-reliability region.

The learning unit 20421 repeatedly executes the processing illustrated in FIG. 18 to perform learning, thereby generating a learning model that receives inputs of the captured image information 201 and the distance measurement information 202 including a flying pixel and outputs the position information (low-reliability region) 203 of the flying pixel (correction target pixel) included in a depth map.

Furthermore, in generating a learning model, the learning unit 20421 can also generate a learning model that receives inputs of the captured image information 201 and the distance measurement information 202 including a flying pixel and outputs an optimized kernel coefficient. In this case, the inference unit 20422 acquires the optimized kernel coefficient by performing the processing from steps S301 to S311. Then, the inference unit 20422 can detect the position information (low-reliability region) 203 of the flying pixel (correction target pixel) by performing an operation as normal processing on the basis of the acquired kernel coefficient. The learning unit 20421 outputs the generated learning model to the inference unit 20422.

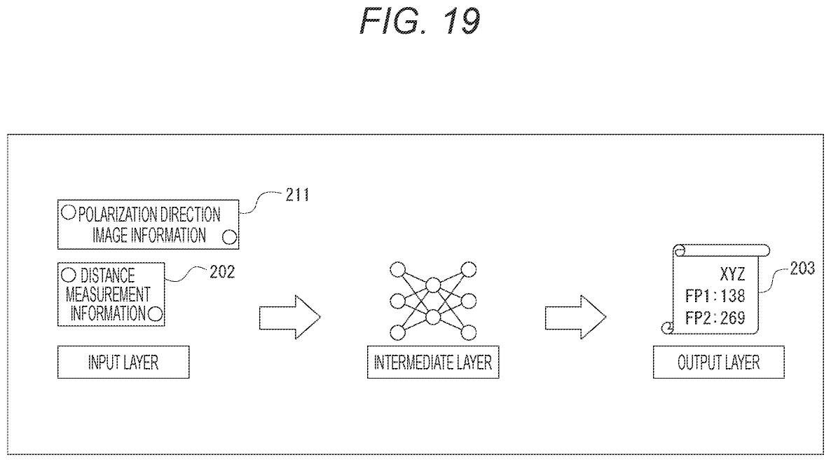

Furthermore, as illustrated in FIG. 19, it is also conceivable to input polarization direction image information 211 instead of the captured image information 201 in generating a learning model. The polarization direction image information 211 is generated on the basis of a polarization image signal based on light polarized in a predetermined polarization direction by a polarizing filter provided in the sensor 20106 (two-dimensional image sensor 20).

FIG. 19 illustrates a machine-learned learning model using a neural network. The learning model is a learning model that receives inputs of the polarization direction image information 211 and the distance measurement information 202 and outputs the position information 203 of the flying pixels (correction target pixels).

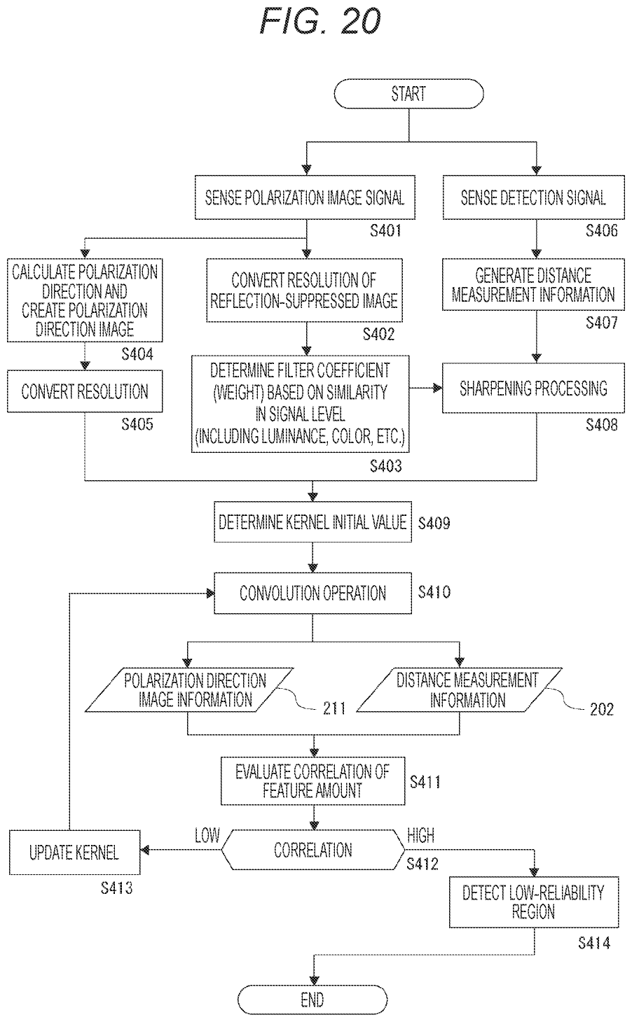

FIG. 20 illustrates a flow of learning processing performed to generate the learning model of FIG. 19.

First, in step S401, a polarization image signal is obtained by sensing. Then, in step S402, resolution conversion of a reflection-suppressed image based on the polarization image signal is performed, and a filter coefficient (weight) is determined on the basis of similarity in a signal level (including luminance, a color, or the like) of the image signal in step S403 on the basis of the resolution conversion.

Furthermore, in step S404, the polarization direction image information 211 is generated by calculating polarization directions of the polarization image signals in four directions obtained by sensing. The resolution of the polarization direction image information 211 is converted in step S405.

On the other hand, from steps S406 to S408, processing similar to that from steps S304 to S306 in FIG. 18 is performed, and the distance measurement information 202 subjected to the sharpening processing using the filter coefficient determined in step S403 is acquired.

The learning unit 20421 acquires the polarization direction image information 211 and the distance measurement information 202 obtained by the processing from step S401 to step 408.

In step S409, the learning unit 20421 determines an initial value of a kernel coefficient, and thereafter, evaluates a correlation while performing convolution of the kernel coefficient in steps S410 to S413. That is, the learning unit 20421 performs the convolution operation of the kernel coefficient in step S410 through the processing in steps S411, S412, and S413 while obtaining the polarization direction image information 211 and the distance measurement information 202 to which the kernel coefficient is applied.

In step S411, the learning unit 20421 evaluates a correlation in a feature amount of each of objects in an image on the basis of the obtained polarization direction image information 211 and distance measurement information 202. That is, the learning unit 20421 recognizes the same plane (feature) of the object from deflection angle distribution of the polarization direction image information 211, and learns a correlation (similarity in in-plane tendency) between the feature described above and the distance measurement information 202 with reference to the polarization direction image information 211.

As a result of the correlation evaluation, when it is determined in step S412 that the correlation is low, the evaluation result is fed back in step S413 to update the kernel coefficient.

Thereafter, the learning unit 20421 performs the processing from steps S410 to S412 on the basis of the updated kernel coefficient. The validity of the updated value of the kernel coefficient is recognized from a previous correlation. The learning unit 20421 updates the kernel coefficient in step 413 and repeatedly executes the processing in steps 410 to S413 until the kernel coefficient has the highest in-plane correlation between the polarization direction image information 211 and the distance measurement information 202.

In step S412, when the updated kernel coefficient becomes the optimized kernel coefficient which obtains the highest in-plane correlation between the polarization direction image information 211 and the distance measurement information 202, the learning unit 20421 advances the processing to step S414. In step S414, the learning unit 20421 detects a pixel of the distance measurement information 202 specifically separated from the polarization direction image information 211 although the in-plane correlation is high as a correction target pixel (flying pixel) having low similarity to the polarization direction image information 211. Then, the learning unit 20421 detects a region including one or a plurality of correction target pixels as a low-reliability region.

The learning unit 20421 repeatedly executes the processing illustrated in FIG. 20 to perform learning, thereby generates a learning model that receives inputs of the polarization direction image information 211 and the distance measurement information 202 and outputs the position information (low-reliability region) 203 of the flying pixel (correction target pixel).

Note that, in generating a learning model, the learning unit 20421 can also generate a learning model that receives inputs of the polarization direction image information 211 and the distance measurement information 202 including a flying pixel and outputs an optimized kernel coefficient that obtains the highest in-plane correlation between the polarization direction image information 211 and the distance measurement information 202.

(B) Processing in Case where Inference Processing is Performed in Correction Step

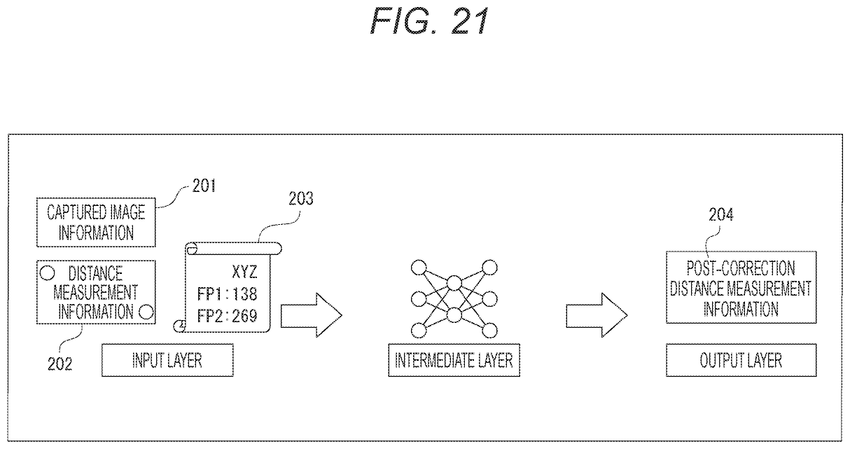

When inference processing is performed in a correction step in a case where a detection step and the correction step are performed in correction processing, the inference unit 20422 uses a learning model that receives inputs of the captured image information 201, the distance measurement information 202 including a correction target pixel, and the position information (detection information) 203 of the correction target pixel (low-reliability region) and outputs the post-correction distance measurement information 204 or the corrected detection information of the correction target pixel as illustrated in FIG. 21. This learning model is generated by learning processing using the learning unit 20421, is provided to the inference unit 20422, and is used when the inference processing is performed.

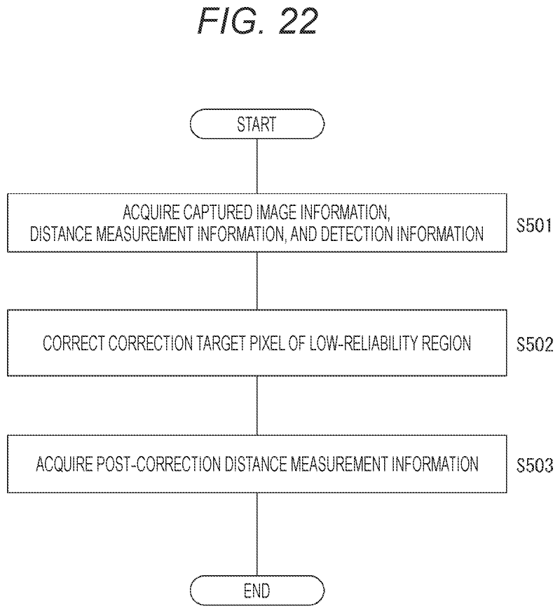

A flow of learning processing performed in advance when the inference processing is performed in the correction step in the case where the detection step and the correction step are performed in the correction processing will be described as follows with reference to a flowchart of FIG. 22.

First, in step S501, the learning unit 20421 acquires the captured image information 201, the distance measurement information 202, and the position information (detection information) 203 of the correction target pixel (low-reliability region).

Subsequently, in step S502, the learning unit 20421 corrects a flying pixel (correction target pixel) in the low-reliability region. At this time, the learning unit 20421 interpolates a feature amount of the flying pixel with reference to luminance, color distribution in the captured image information 201 (G signal level distribution in a case where the captured image information 201 is based on a G signal) and a depth map (distance measurement information). Therefore, in step S503, the learning unit 20421 obtains post-correction distance measurement information. At this time, corrected detection information of the correction target pixel may be obtained instead of the post-correction distance measurement information.

The learning unit 20421 repeatedly executes the processing illustrated in FIG. 22 to perform learning, thereby generating a learning model that receives inputs of the captured image information 201, the distance measurement information 202 including the correction target pixel, and the position information (detection information) 203 of the correction target pixel (low-reliability region) and outputs the post-correction distance measurement information 204 or the corrected detection information of the correction target pixel. The learning unit 20421 outputs the generated learning model to the inference unit 20422.

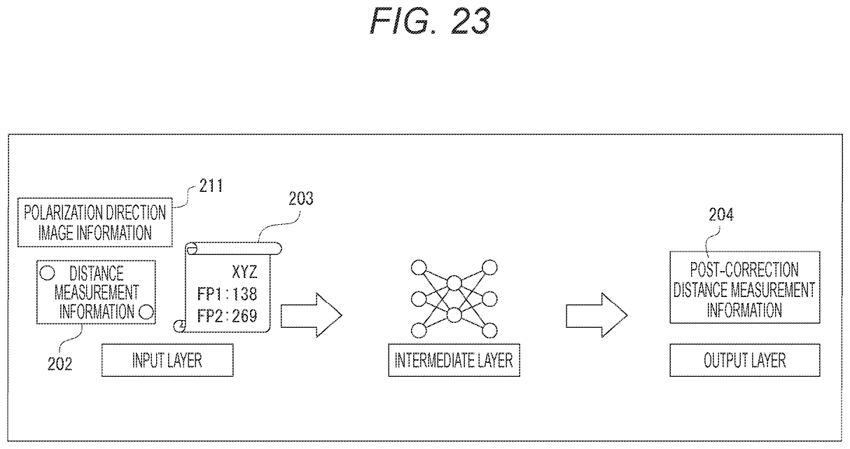

Furthermore, when the inference processing is performed in the correction step the inference unit 20422 may use a learning model that receives inputs of the polarization direction image information 211, the distance measurement information 202 including the correction target pixel, and the position information (detection information) 203 of the correction target pixel (low-reliability region) and the post-correction distance measurement information 204 or the corrected detection information of the correction target pixel as illustrated in FIG. 23.

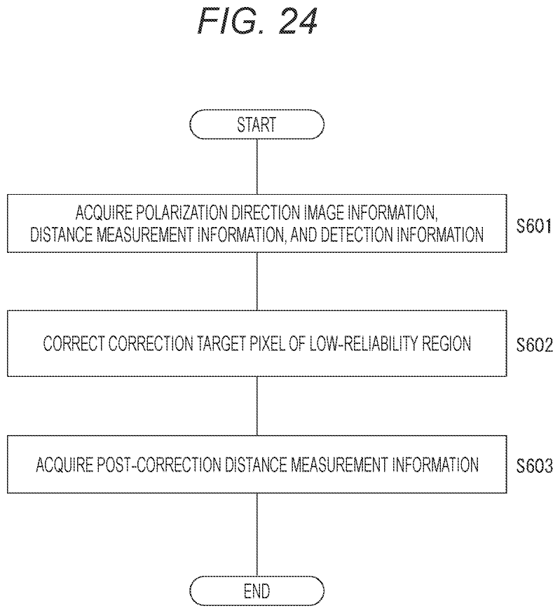

A flow of learning processing performed in advance when the inference processing is performed in the correction step in the case where the detection step and the correction step are performed in the correction processing will be described as follows with reference to a flowchart of FIG. 24.

In this case, the learning unit 20421 acquires the polarization direction image information 211, the distance measurement information 202, and the position information (detection information) 203 of the correction target pixel (low-reliability region) in step S601, and corrects a flying pixel (correction target pixel) in the low-reliability region in step S602. At this time, the learning unit 20421 interpolates a feature amount of the flying pixel with reference to polarization angle distribution and the depth map (distance measurement information) in the polarization direction image information 211. Therefore, the learning unit 20421 obtains post-correction distance measurement information in step S603. At this time, corrected detection information of the correction target pixel may be obtained instead of the post-correction distance measurement information.

The learning unit 20421 repeatedly executes the processing described above to perform learning, thereby generating a learning model that receives inputs of the polarization direction image information 211, the distance measurement information 202 including the correction target pixel, and the position information (detection information) 203 of the correction target pixel (low-reliability region) and outputs the post-correction distance measurement information 204 or the corrected detection information of the correction target pixel. The learning unit 20421 outputs the generated learning model to the inference unit 20422.

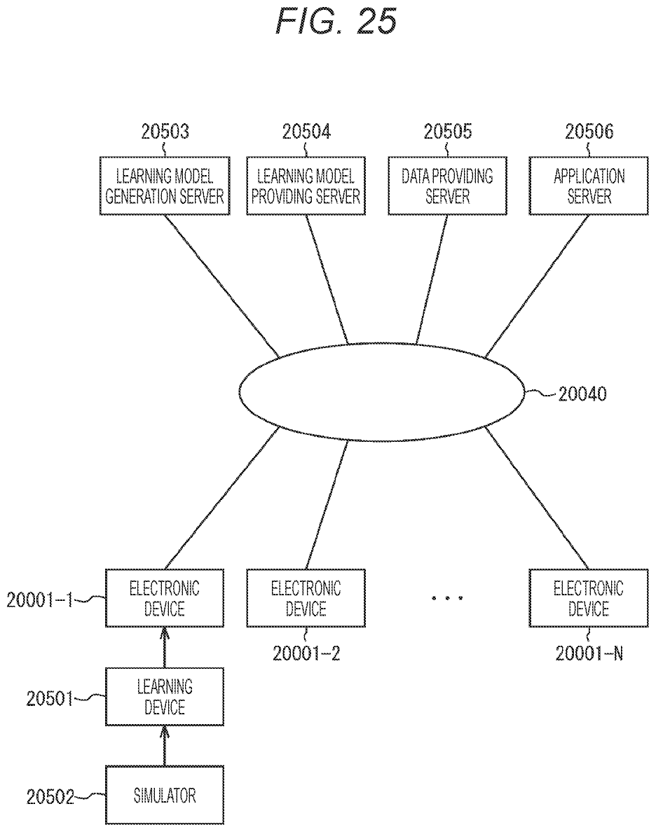

Incidentally, the data such as the learning model, the distance measurement information, the captured image information (polarization direction image information), and the post-correction distance measurement information may be used in a single device or may be exchanged between a plurality of devices and used in those devices. FIG. 25 illustrates a flow of data between a plurality of devices.

Electronic devices 20001-1 to 20001-N(N is an integer of 1 or more) are possessed by each user, for example, and can be connected to the network 20040 such as the Internet via a base station (not illustrated) or the like. At the time of manufacturing, a learning device 20501 is connected to the electronic device 20001-1, and the learning model provided by the learning device 20501 can be recorded in the auxiliary memory 20104. The learning device 20501 generates a learning model by using a data set generated by a simulator 20502 as teacher data and provides the learning model to the electronic device 20001-1. Note that the teacher data is not limited to the data set provided from the simulator 20502, and distance measurement information and captured image information (polarization direction image information) actually acquired by the respective sensors, acquired distance measurement information and captured image information (polarization direction image information) which are aggregated and managed, and the like may be used.

Although not illustrated, the learning model can be recorded in the electronic devices 20001-2 to 20001-N at the stage of manufacturing, similarly to the electronic device 20001-1. Hereinafter, the electronic devices 20001-1 to 20001-N will be referred to as electronic devices 20001 in a case where it is not necessary to distinguish the electronic devices from each other.

In addition to the electronic device 20001, a learning model generation server 20503, a learning model providing server 20504, a data providing server 20505, and an application server 20506 are connected to the network 20040, and can exchange data with each other. Each server can be provided as a cloud server.

The learning model generation server 20503 has a configuration similar to that of the cloud server 20003, and can perform learning processing by a processor such as a CPU. The learning model generation server 20503 generates a learning model using the teacher data. In the illustrated configuration, the case where the electronic device 20001 records the learning model at the time of manufacturing is exemplified, but the learning model may be provided from the learning model generation server 20503. The learning model generation server 20503 transmits the generated learning model to the electronic device 20001 via the network 20040. The electronic device 20001 receives the learning model transmitted from the learning model generation server 20503 and records the learning model in the auxiliary memory 20104. Therefore, the electronic device 20001 including the learning model is generated.

That is, in the electronic device 20001, in a case where the learning model is not recorded at the stage of manufacturing, the electronic device 20001 recording the new learning model is generated by newly recording the learning model from the learning model generation server 20503. Furthermore, in the electronic device 20001, in a case where the learning model has already been recorded at the stage of manufacturing, the electronic device 20001 recording the updated learning model is generated by updating the recorded learning model to the learning model from the learning model generation server 20503. The electronic device 20001 can perform inference processing using a learning model that is appropriately updated.

The learning model is not limited to being directly provided from the learning model generation server 20503 to the electronic device 20001, and may be provided by the learning model providing server 20504 that aggregates and manages various learning models via the network 20040. The learning model providing server 20504 may generate another device including a learning model by providing the learning model to the other device, not limited to the electronic device 20001. Furthermore, the learning model may be provided by being recorded in a detachable memory card such as a flash memory. The electronic device 20001 can read and record the learning model from the memory card attached to the slot. Therefore, the electronic device 20001 can acquire the learning model even in a case of being used in a severe environment, in a case where there is no communication function, in a case where there is a communication function but the amount of information that can be transmitted is small, or the like.

The electronic device 20001 can provide data such as the distance measurement information, the captured image information (polarization direction image information), the post-correction distance measurement information, and the metadata to another device via the network 20040. For example, the electronic device 20001 transmits data such as the distance measurement information, the captured image information (polarization direction image information), and the post-correction distance measurement information to the learning model generation server 20503 via the network 20040. Therefore, the learning model generation server 20503 can generate a learning model by using, as teacher data, data such as the distance measurement information, the captured image information (polarization direction image information), and the post-correction distance measurement information collected from one or a plurality of the electronic devices 20001. As more teacher data is used, the accuracy of the learning processing can be improved.

The data such as the distance measurement information, the captured image information (polarization direction image information), and the post-correction distance measurement information is not limited to be directly provided from the electronic device 20001 to the learning model generation server 20503, and may be provided by the data providing server 20505 that aggregates and manages various types of data. The data providing server 20505 may collect data from not only the electronic device 20001 but also another device, or may provide data to not only the learning model generation server 20503 but also another device.

The learning model generation server 20503 may update a learning model by performing, on an already generated learning model, relearning processing in which data, such as distance measurement information, captured image information (polarization direction image information), and post-correction distance measurement information provided from the electronic device 20001 or the data providing server 20505, is added to teacher data. The updated learning model can be provided to the electronic device 20001. In a case where learning processing or relearning processing is performed in the learning model generation server 20503, processing can be performed regardless of a difference in specification or performance of the electronic device 20001.

Furthermore, in the electronic device 20001, in a case where the user has performed a modifying operation on the corrected data or the metadata (for example, in a case where the user inputs correct information), feedback data regarding such modification processing may be used for the relearning processing. For example, by transmitting the feedback data from the electronic device 20001 to the learning model generation server 20503, the learning model generation server 20503 can perform relearning processing using the feedback data from the electronic device 20001 and update the learning model. Note that, in the electronic device 20001, an application provided by the application server 20506 may be used when the user performs a modifying operation.

The relearning processing may be performed by the electronic device 20001. In a case where the electronic device 20001 updates a learning model by performing the relearning processing using the distance measurement information, the captured image information (polarization direction image information), and the feedback data, the learning model can be improved in the device. Therefore, the electronic device 20001 including the updated learning model is generated. Furthermore, the electronic device 20001 may transmit the learning model after update obtained by the relearning processing to the learning model providing server 20504 so as to be provided to another electronic device 20001. Therefore, the learning model after the update can be shared among the plurality of electronic devices 20001.

Alternatively, the electronic device 20001 may transmit difference information of the relearned learning model (difference information regarding the learning model before update and the learning model after update) to the learning model generation server 20503 as update information. The learning model generation server 20503 can generate an improved learning model on the basis of the update information from the electronic device 20001 and provide the improved learning model to another electronic device 20001. By exchanging such difference information, privacy can be protected and communication cost can be reduced as compared with a case where all information is exchanged. Note that, similarly to the electronic device 20001, the optical sensor 20011 mounted on the electronic device 20001 may perform the relearning processing.

The application server 20506 is a server capable of providing various applications via the network 20040. An application provides a predetermined function using data such as a learning model, corrected data, or metadata. The electronic device 20001 can implement a predetermined function by executing an application downloaded from the application server 20506 via the network 20040. Alternatively, the application server 20506 can also implement a predetermined function by acquiring data from the electronic device 20001 via, for example, an application programming interface (API) or the like and executing an application on the application server 20506.

In this manner, in a system including devices to which the present technology is applied, data such as a learning model, distance measurement information, captured image information (polarization direction image information), and post-correction distance measurement information is exchanged and distributed among the devices, and various services using these pieces of data can be provided. For example, it is possible to provide a service that provides a learning model via the learning model providing server 20504 and a service that provides data such as the distance measurement information, the captured image information (polarization direction image information), and the post-correction distance measurement information via the data providing server 20505. Furthermore, it is possible to provide a service for providing an application via the application server 20506.

Alternatively, the distance measurement information acquired from the optical sensor 20011 of the electronic device 20001 and the captured image information (polarization direction image information) acquired from the sensor 20106 may be input to a learning model provided by the learning model providing server 20504, and post-correction distance measurement information obtained as an output may be provided. Furthermore, a device such as an electronic device on which the learning model provided by the learning model providing server 20504 is equipped may be generated and provided. Moreover, by recording data such as the learning model, the corrected data, and the metadata in a readable storage medium, a device such as a storage medium in which the data is recorded or an electronic device on which the storage medium is mounted may be generated and provided. The storage medium may be a nonvolatile memory such as a magnetic disk, an optical disk, a magneto-optical disk, or a semiconductor memory, or may be a volatile memory such as an SRAM or a DRAM.

<7. Summary>

The information processing device according to the embodiment of the present technology described above performs processing using a machine-learned learning model for at least a part of the first distance measurement information 202 acquired by a first sensor (the optical sensor 20011 or the two-dimensional distance measuring sensor 10). Here, the information processing device is, for example, the electronic device 20001, the edge server 20002, the cloud server 20003, the optical sensor 20011, or the like in FIG. 9.

Furthermore, the information processing device includes the processing unit 20401 that outputs second distance measurement information (the post-correction distance measurement information 204) after being subjected to correction of a correction target pixel (low-reliability region) included in the first distance measurement information 202 (see FIGS. 1, 17, and 21, and the like).

Furthermore, the processing in the processing unit 20401 described above includes first processing (S207 in FIG. 14) of correcting the correction target pixel and second processing (S208 in FIG. 14) of outputting the second distance measurement information (post-correction distance measurement information 204) with the first distance measurement information 202 including the correction target pixel and the image information (the captured image information 201 or the polarization direction image information 211) acquired by a second sensor (the sensor 20106 or the two-dimensional image sensor 20) as inputs.

Therefore, the post-correction distance measurement information 204 based on a correlation between the image information (the captured image information 201 or the polarization direction image information 211) and the distance measurement information 202 is output using the machine-learned learning model. Therefore, the accuracy of detecting a flying pixel included in the distance measurement information 202 is improved, and the post-correction distance measurement information 204 with less error can be obtained.

In the information processing device according to the embodiment, image information (the captured image information 201) based on a signal obtained by photoelectrically converting visible light is used as an input in the first processing (S207 in FIG. 14). With the input, it is possible to obtain the post-correction distance measurement information 204 based on a correlation (similarity in in-plane tendency) between an object (feature), recognized from luminance and color distribution of the captured image information 201, and the distance measurement information 202.

Furthermore, in the first processing (S207 in FIG. 14), image information (the polarization direction image information 211) based on a signal obtained by photoelectrically converting light polarized in a predetermined direction can also be used as an input. This is particularly applied when a learning model generated by the processing of FIGS. 20 and 24 is used in step S20021 or S20022 of FIG. 15 in the first processing (correction processing). In step S20021, the inference unit 20422 in FIG. 13 receives inputs of the polarization direction image information 211 and the distance measurement information 202, and outputs the position information 203 of the flying pixel (correction target pixel). Furthermore, in step S20022, the inference unit 20422 receives inputs of the polarization direction image information 211, the distance measurement information 202, and the position information 203, and outputs the post-correction distance measurement information 204. Note that the inference unit 20422 can also receive an input of the captured image information 201 instead of the polarization direction image information 211 as the input in step S20021. In this case, the inference unit 20422 can obtain the polarization direction image information 211 from the captured image information 201 by performing the processing from steps S401 to S408 in FIG. 20 instead of the processing from steps S201 to S206 in FIG. 14. With the input, it is possible to obtain the post-correction distance measurement information 204 based on the correlation (similarity in in-plane tendency) between the same plane (feature) of the object recognized from the deflection angle distribution of the polarization direction image information 211 and the distance measurement information 202.

In the information processing device according to the embodiment, the learning model includes a neural network trained with a data set detecting the correction target pixel (FIGS. 17 and 19). As characteristic learning is repeatedly performed using the neural network, it is possible to learn a complex pattern hidden in a large amount of data. Therefore, the output accuracy of the post-correction distance measurement information 204 can be further improved.

In the information processing device according to the embodiment, the first processing (S207 in FIG. 14) includes a first step (S20021 in FIG. 15) of detecting the correction target pixel. Furthermore, the first processing (S207 in FIG. 14) includes a second step (S20022 in FIG. 15) of correcting the detected correction target pixel.

At this time, processing using the learning model is performed in the first step (S20021 in FIG. 15) or the second step (S20022 in FIG. 15). Therefore, the detection of the correction target pixel or the correction of the correction target pixel is accurately output using the learning model.

Furthermore, the processing using the learning model can be performed in the first step (S20021 in FIG. 15) and the second step (S20022 in FIG. 15). Since the learning model is used for both the processing of detecting the correction target pixel and the processing of correcting the correction target pixel, the output can be performed with higher accuracy.

The information processing device according to the embodiment further includes a first sensor (the optical sensor 20011 or the two-dimensional distance measuring sensor 10), and the first sensor (the optical sensor 20011 or the two-dimensional distance measuring sensor 10) includes the processing unit 20401. Therefore, for example, the optical sensor 20011 (for example, the filter unit 16 of the two-dimensional distance measuring sensor 10 in FIG. 1) performs inference processing.

In a case where the inference processing is performed by the optical sensor 20011, the inference processing can be performed without requiring time after the distance measurement information is acquired, and thus, the processing can be performed at high speed. Therefore, when the information processing device is used for applications requiring the real-time property, the user can perform an operation without discomfort due to delay. Furthermore, in a case where machine learning processing is performed by the optical sensor 20011, the processing can be implemented at lower cost than that in a case where a server (the edge server 20002 or the cloud server 20003) is used.

Note that the effects described in the present disclosure are merely examples and are not limited, and other effects may be exhibited, or some of the effects described in the present disclosure may be exhibited.

Furthermore, the embodiment described in the present disclosure is merely an example, and the present technology is not limited to the above-described embodiment. Therefore, it is a matter of course that various changes can be made according to a design and the like without departing from the technical idea of the present technology, in addition to the embodiment described above. Note that not all combinations of the configurations described in the embodiments are essential for solving the problem.

<8. Others>

Note that the present technology can also have the following configuration.
(1)

An electronic device including
a processing unit that performs processing using a machine-learned learning model on at least a part of first distance measurement information acquired by a first sensor, and outputs second distance measurement information after being subjected to correction of a correction target pixel included in the first distance measurement information,
in which the processing includes
first processing of correcting the correction target pixel using the first distance measurement information including the correction target pixel and image information acquired by a second sensor as inputs, and
second processing of outputting the second distance measurement information.

(2)

The electronic device according to (1) described above, in which
in the first processing, the image information based on a signal obtained by photoelectrically converting visible light is used as the input.

(3)

The electronic device according to (1) described above, in which
in the first processing, the image information based on a signal obtained by photoelectrically converting light polarized in a predetermined direction is used as the input.

(4)

The electronic device according to any one of (1) to (3) described above, in which
the learning model includes a neural network trained with a data set detecting the correction target pixel.

(5)

The electronic device according to any one of (1) to (4) described above, in which
the first processing includes a first step of detecting the correction target pixel.

(6)

The electronic device according to (5) described above, in which
the first processing includes a second step of correcting the detected correction target pixel.

(7)

The electronic device according to (6) described above, in which
in the first step or the second step, processing using the learning model is performed.

(8)

The electronic device according to (6) described above, in which
in the first step and the second step, processing using the learning model is performed.

(9)

The electronic device according to any one of (1) to (8) described above, in which
the first distance measurement information is a pre-correction depth map, and
the second distance measurement information is a post-correction depth map.

(10)

The electronic device according to any one of (1) to (9) described above, in which
the correction target pixel is a flying pixel.

(11)

The electronic device according to any one of (1) to (10) described above, further including
the first sensor,
in which the first sensor includes the processing unit.

(12)

The electronic device according to any one of (1) to (11) described above, being configured as a mobile terminal or a server.

### REFERENCE SIGNS LIST

1 Distance measuring system
10 Two-dimensional distance measuring sensor
11 Lens
12 Light receiving unit
13 Signal processing unit
14 Light emitting unit
15 Light emission control unit
16 Filter unit
20 two-dimensional image sensor
21 Light receiving unit
22 Signal processing unit
201 Captured image information
202 Distance measurement information
203 Position information (detection information)
204 Post-correction distance measurement information
211 Polarization direction image information
20001 Electronic device
20002 Edge server
20003 Cloud server
20011 Optical sensor
20106 Sensor
20401 Processing unit

1. An information processing device comprising
a processing unit that performs processing using a machine-learned learning model on at least a part of first distance measurement information acquired by a first sensor, and outputs second distance measurement information after being subjected to correction of a correction target pixel included in the first distance measurement information,
wherein the processing includes
first processing of correcting the correction target pixel using the first distance measurement information including the correction target pixel and image information acquired by a second sensor as inputs, and
second processing of outputting the second distance measurement information.

2. The information processing device according to claim 1, wherein
in the first processing, the image information based on a signal obtained by photoelectrically converting visible light is used as the input.

3. The information processing device according to claim 1, wherein
in the first processing, the image information based on a signal obtained by photoelectrically converting light polarized in a predetermined direction is used as the input.

4. The information processing device according to claim 1, wherein
the learning model includes a neural network trained with a data set detecting the correction target pixel.

5. The information processing device according to claim 1, wherein
the first processing includes a first step of detecting the correction target pixel.

6. The information processing device according to claim 5, wherein
the first processing includes a second step of correcting the detected correction target pixel.

7. The information processing device according to claim 6, wherein
in the first step or the second step, processing using the learning model is performed.

8. The information processing device according to claim 6, wherein
in the first step and the second step, processing using the learning model is performed.

9. The information processing device according to claim 1, wherein
the first distance measurement information is a pre-correction depth map, and
the second distance measurement information is a post-correction depth map.

10. The information processing device according to claim 1, wherein
the correction target pixel is a flying pixel.

11. The information processing device according to claim 1, further comprising
the first sensor, and
the first sensor includes the processing unit.

12. The information processing device according to claim 1, being configured as a mobile terminal or a server.
